(19) United States
(12) Patent Application Publication
(10) Pub. No.: US 2026/0095796 A1
(43) Pub. Date: Apr. 2, 2026

(54) TIMING ADVANCE FOR POSITIONING

(71) Applicant: Lenovo (Singapore) Pte. Limited, Singapore (SG)

(72) Inventors: Sher Ali Cheema, Ilmenau (DE); Robin Rajan Thomas, Bad Nauheim (DE); Vijay Nangia, Woodridge, IL (US); Majid Ghanbarinejad, Lake Forest, CA (US)

(73) Assignee: Lenovo (Singapore) Pte. Limited, Singapore (SG)

(21) Appl. No.: 19/111,710

(22) PCT Filed: Oct. 17, 2023
(86) PCT No.: PCT/IB2023/060492

§ 371 Date: Mar. 13, 2025

Related U.S. Application Data
(60) Provisional application No. 63/418,450, filed on Oct. 21, 2022.
(60) Provisional application No. 63/418,455, filed on Oct. 21, 2022.

(51) Int. Cl. H04W 24/10; H04W 56/00

(52) U.S. Cl. CPC H04W 24/10; H04W 56/0045

(57) ABSTRACT

Various aspects of the present disclosure relate to methods, apparatuses, and systems that support TA for positioning. For instance, implementations provide a set of signalling and procedural enhancements to enable the support of timing advance (TA) based and/or TA-assisted positioning procedures over non-terrestrial supported networks. Further, application and configuration aspects for TA-based and/or TA-assisted positioning are provided for both single and multiple satellite systems.

### RELATED APPLICATIONS

This application claims priority to U.S. Provisional Application Ser. No. 63/418,450 filed 21 Oct. 2022 entitled “TIMING ADVANCE FOR POSITIONING,” the disclosure of which is incorporated by reference herein in its entirety. This application also claims priority to U.S. Provisional Application Ser. No. 63/418,455 filed 21 Oct. 2022 entitled “TIMING ADVANCE FOR POSITIONING,” the disclosure of which is incorporated by reference herein in its entirety.

### TECHNICAL FIELD

The present disclosure relates to wireless communications, and more specifically to positioning in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for device (e.g., UE) positioning. Such systems, however, may not provide support for certain procedures for device positioning, particularly procedures that involve non-terrestrial networks.

### SUMMARY

The present disclosure relates to methods, apparatuses, and systems that support timing advance (TA) for positioning. For instance, implementations provide a set of signalling and procedural enhancements to enable the support of TA based positioning procedures over an NTN supported network. Further, application and configuration aspects for TA-based positioning are provided for both single and multiple satellite systems.

By utilizing the described techniques, accurate and efficient determine of device location can be achieved.

Some implementations of the methods and apparatuses described herein may further include receiving an assistance configuration message indicating to perform a plurality of TA measurements corresponding to a plurality of measurement time instances, wherein: each measurement time instance is associated with at least one cell, and the assistance configuration message includes TA related parameters and measurement reference signal configuration corresponding to the at least one cell; performing at least one TA measurement corresponding to at least one of the plurality of measurement time instances and based at least in part on the received assistance configuration message; and transmitting a TA positioning report including the at least one TA measurement.

Some implementations of the methods and apparatuses described herein may further include: where the TA related parameters include at least one of satellite ephemeris information, epoch time, common TA parameters, or validity duration; the plurality of measurement time instances includes time instances within a validity duration; the assistance configuration message includes a measurement instance separation information, and determining the plurality of measurement time instances based at least in part on the measurement instance separation information; a first subset of the plurality of measurement time instances includes time instances within a first validity duration, and a second subset of the plurality of measurement time instances includes time instances within a second validity duration; the first validity duration is associated with a first set of one or more of satellite ephemeris or common TA parameters, and the second validity duration is associated with a second set of one or more of satellite ephemeris or common TA parameters.

Some implementations of the methods and apparatuses described herein may further include: where a first subset of the plurality of measurement time instances is associated with a first cell of the at least one cell, and a second subset of the plurality of measurement time instances is associated with a second cell of the at least one cell; further including receiving a TA parameter broadcast message for positioning, and where the TA parameter broadcast message includes information about at least one of satellite ephemeris info, epoch time, common TA parameters, validity duration, or reference point; further including receiving the TA parameter broadcast message periodically, and where the TA parameter broadcast message is associated with at least one validity duration; receiving a capability information request from a network related to TA based positioning; and transmitting one or more capability parameters based at least in part on the capability information request; the capability information request includes information about indication of support for TA calculations for positioning; the capability information request includes information about support of user specific TA location estimate method; the one or more capability parameters include at least one of an indication of support of TA positioning calculation for positioning, a user-specific TA location estimate method, a number of satellite nodes in a coverage area, or polarization capability.

Some implementations of the methods and apparatuses described herein may further include transmitting an assistance configuration message indicating to perform a plurality of TA measurements corresponding to a plurality of measurement time instances, wherein: each measurement time instance is associated with at least one cell, and the assistance configuration message includes TA related parameters and measurement reference signal configuration corresponding to the at least one cell; and receiving a TA positioning report including at least one TA measurement based at least in part on the assistance configuration message.

Some implementations of the methods and apparatuses described herein may further include: where the TA related parameters include at least one of satellite ephemeris information, epoch time, common TA parameters, or validity duration; the plurality of measurement time instances includes time instances within a validity duration; the assistance configuration message includes a measurement instance separation information; a first subset of the plurality of measurement time instances includes time instances within a first validity duration, and a second subset of the plurality of measurement time instances includes time instances within a second validity duration; the first validity duration is associated with a first set of one or more of satellite ephemeris or common TA parameters, and the second validity duration is associated with a second set of one or more of satellite ephemeris or common TA parameters; further including: transmitting, from a network related to TA based positioning, a capability information request; and receiving one or more capability parameters based at least in part on the capability information request.

### BRIEF DESCRIPTION OF THE DRAWINGS

FIG. 1 illustrates an example of a wireless communications system that supports TA for positioning in accordance with aspects of the present disclosure.

FIG. 2 illustrates a system in which positioning reference signals can be utilized to obtain positioning measurements.

FIG. 3 illustrates an example of assistance data configuration implementation with respect to UE measurement and report configuration signaling applicable to downlink-based positioning techniques.

FIG. 4 illustrates an example of a positioning measurement report.

FIG. 5 illustrates an example architecture applicable to an NG-RAN for UE positioning.

FIG. 6 illustrates a sequence of signaling events.

FIG. 7 illustrates a transparent satellite-based NG-RAN architecture.

FIG. 8 illustrates an example of a transparent satellite-based NG-RAN architecture with mapping to quality of service (QoS) flows.

FIG. 9 illustrates an example of the UE user plane protocol stack for the transparent satellite-based NG-RAN architecture.

FIG. 10 illustrates an example of the control plane protocol stack for the transparent satellite-based NG-RAN architecture.

FIG. 11 illustrates a regenerative satellite-based NG-RAN architecture, such as a regenerative satellite without an inter-satellite link (ISL), and with a gNB-processed payload.

FIG. 12 illustrates another example of a regenerative satellite-based NG-RAN architecture, such as a regenerative satellite system with an ISL.

FIG. 13 illustrates an example of a regenerative satellite-based NG-RAN architecture with gNB onboard, and the QoS flows.

FIG. 14 illustrates an example of the UE user plane protocol stack for a PDU session.

FIG. 15 illustrates an example of the UE control plane protocol stack for a PDU session.

FIG. 16 illustrates an example of open loop TA in NTN.

FIG. 17 illustrates an example where TA measurements at multiple time instances may be performed.

FIG. 18 depicts an example error IE that supports TA for positioning in accordance with aspects of the present disclosure.

FIG. 19 depicts an example error IE that supports TA for positioning in accordance with aspects of the present disclosure.

FIG. 20 depicts an example TA measurement procedure that supports TA for positioning in accordance with aspects of the present disclosure.

FIG. 21 depicts an example TA capabilities request IE that supports TA for positioning in accordance with aspects of the present disclosure.

FIG. 22 depicts an example TA capabilities response IE that supports TA for positioning in accordance with aspects of the present disclosure.

FIG. 23 depicts an example information exchange procedure that supports TA for positioning in accordance with aspects of the present disclosure.

FIG. 24 depicts an example TA assistance data IE that supports TA for positioning in accordance with aspects of the present disclosure.

FIGS. 25a and 25b illustrate example scenarios that supports TA for positioning in accordance with aspects of the present disclosure.

FIGS. 26 and 27 illustrate example block diagrams of devices that support TA for positioning in accordance with aspects of the present disclosure.

FIGS. 28-33 illustrate flowcharts of methods that support TA for positioning in accordance with aspects of the present disclosure.

### DETAILED DESCRIPTION

In wireless communications systems, a concern is to enable the configuration, measurement, processing, and reporting for radio access technology (RAT)-dependent positioning for target UEs connected to a non-terrestrial based network without significantly degrading positioning accuracy and latency. For instance, depending on a configured positioning method, certain configuration signalling parameters from a network function would need to be adapted such that a target UE can report the desired as well as accurate positioning measurements in a low latency manner. Specifically, in non-terrestrial networks (NTN), the number of satellites that provide coverage to a UE may be limited. This may indicate that positioning methodologies may function with only one satellite. Moreover, regulatory and emergency requirements in NTN may not specify sufficiently accurate positioning parameters. Regarding the use of TA procedures in device positioning, current wireless communications systems do not provide support for such procedures, particularly in the context of NTN.

Accordingly, this disclosure provides for techniques that support TA for positioning. For instance, implementations provide a set of signalling and procedural enhancements to enable the support of TA based positioning procedures over an NTN supported network. Further, application and configuration aspects for TA-based positioning are provided for both single and multiple satellite systems.

For instance, in implementations a location server (e.g., LMF) exchanges TA positioning capabilities with a target UE and Next Generation Radio Access (NG-RAN) node (e.g., using LTE Positioning Protocol (LPP) and NR Positioning Protocol Annex (NRPPa) signalling) and based on the exchanged capabilities information, the location server configures parameters to the target UE to calculate TA estimates and/or location estimates with reference to a single satellite at different orbital coordinates. In such scenarios, LLP can be used as an end-to-end protocol between a location server and a target UE in order to estimate the location of the target UE.

Implementations also provide signalling (e.g. LPP signaling) as an end-to-end protocol between a location server and a target UE to exchange capabilities to implement TA positioning procedures, where the location server can initiate a capability transfer procedure using request and provide capabilities messages to enable the transfer of capabilities related to support of TA-based positioning procedures from the target UE to the location server.

In implementations, NRPPa location information transfer procedures are used to handle the transfer of TA-based positioning-related information between an NTN NG-RAN node and a location server (e.g., LMF). Further, based on the capability exchange information (e.g., from a target UE and/or NG-RAN node), the location server can configure the target user with the assistance that may be used in estimation of target UE location, and the location server may exchange request and provide assistance data (e.g., positioning configuration) messages for assistance date.

In implementations, a location server configures TA parameters to a target UE where the TA parameters are related to multiple satellites and/or cell-IDs that may be serving to one NG-RAN node or multiple NG-RAN nodes. The configuration indicated by the TA parameters, for instance, may be based on information received during capability exchange between the location server and the target UE and/or between the location server and NG-RAN node(s).

Thus, by utilizing the described techniques, accurate and efficient determination of device location can be achieved.

Aspects of the present disclosure are described in the context of a wireless communications system. Aspects of the present disclosure are further illustrated and described with reference to device diagrams and flowcharts.

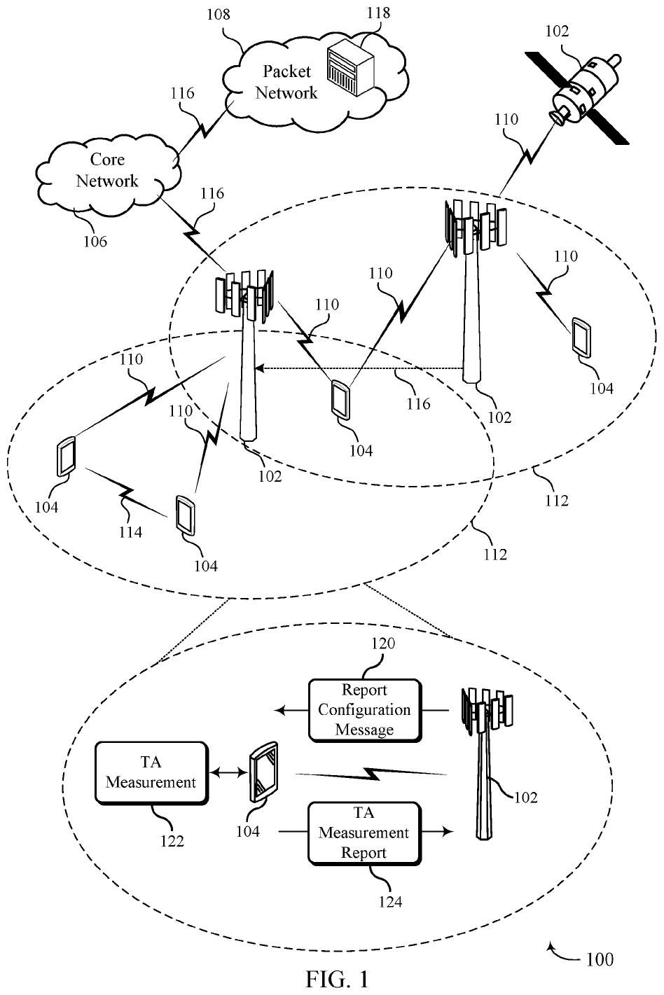

FIG. 1 illustrates an example of a wireless communications system 100 that supports TA for positioning in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, media access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHz), FR4 (52.6 GHz-114.25 GHZ), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for TA for positioning, a network entity 102 (e.g., LMF, location server, etc.) generates an assistance configuration message 120 and transmits the assistance configuration message 120 to a UE 104. The assistance configuration message 120, for instance, indicates to perform a plurality of TA measurements corresponding to a plurality of measurement time instances, where each measurement time instance is associated with at least one cell, and the assistance configuration message 120 includes TA related parameters and measurement reference signal configuration corresponding to the at least one cell.

The UE 104 receives the assistance configuration message 120 and performs TA measurement 122 based at least in part on information (e.g., timing information and TA related parameters) from the assistance configuration message 120. The UE 104 generates a TA measurement report 124 that includes the TA measurements and transmits the TA measurement report 124 to the network entity 102. The network entity 102 may utilize TA measurements from the TA measurement report 124 to estimate a position and/or location of the UE 104.

In some wireless communications systems, NR positioning based on NR Uu signals and Stand Along (SA) architecture (e.g. beam-based transmissions) are specified. The target use cases include commercial and regulatory (emergency services) scenarios. The performance parameters include the following [Technical Report (TR) 38.855]:

| Positioning Error | Indoor | Outdoor |
|---|---|---|
| Horizontal Positioning | <3 m for 80% of UEs | <10 m for 80% of UEs |
| Vertical Positioning | <3 m for 80% of UEs | <3 m for 80% of UEs |

Further, some systems specify positioning performance parameters for commercial and IIoT use cases as follows [TR 38.857]:

| Positioning Error | Commercial | IIoT |
|---|---|---|
| Horizontal Positioning | (<1 m) for 90% | (<0.2 m) for 90% |
| | of UEs | of UEs; |
| Vertical Positioning | (<3 m) for 90% | (<1 m) for 90% |
| | of UEs | of UEs |
| Physical layer latency for | (<10 ms) | (<10 ms) |
| position estimation of UE | | |
| End-to-End Latency for | (<100 ms) | (<100 ms, in the order |
| position estimation of UE | | of 10 ms is desired) |

At least some supported positioning techniques are as follows in Table 1 [TS38.305]:

TABLE 1

| | | UE- | NG-RAN | |
|---|---|---|---|---|
| | UE- | assisted, | node | |
| Method | based | LMF-based | assisted | SUPL |
| A-GNSS | Yes | Yes | No | Yes (UE-based |
| | | | | and UE-assisted) |
| OTDOA ^{Note1, Note 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{NOTE 1}:
This includes Terrestrial Beacon System (TBS) positioning based on PRS signals.
^{NOTE 2}:
In this version of the specification only OTDOA based on LTE signals is supported.
NOTE 3:
Void.
^{NOTE 4}:
This includes Cell-Identifier (Cell-ID) for NR method.
^{NOTE 5}:
In this version of the specification only for TBS positioning based on Metropolitan Beacon System (MBS) signals.
NOTE 6:
Void

Separate positioning techniques as indicated in Error! Reference source not found. can be currently configured and performed based on the requirements of the LMF and UE capabilities. The transmission of Positioning Reference Signals (PRS) enable the UE to perform UE positioning-related measurements to enable the computation of a UE's location estimate and are configured per Transmission Reception Point (TRP), where a TRP may transmit one or more beams.

The following RAT-dependent positioning techniques can be supported [TS38.305]:

Downlink time difference of arrival (DL-TDOA) positioning methods make use of the DL Reference Signal Time Difference (RSTD) (and optionally DL PRS Reference Signal Received Power (RSRP)) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

DL AoD positioning methods make use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

Multi-Round Trip Time (RTT) positioning methods make use of the UE Rx-Tx measurements and DL PRS RSRP of downlink signals received from multiple TRPs, measured by the UE and the measured gNB Rx-Tx measurements and Uplink (UL) Sounding Reference Signal (SRS)-RSRP at multiple TRPs of uplink signals transmitted from UE. The UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the RTT at the positioning server which are used to estimate the location of the UE.

In an Enhanced Cell Identifier (E-CID) positioning method, the position of a UE is estimated with the knowledge of its serving ng-eNB, gNB and cell and is based on LTE signals. The information about the serving ng-eNB, gNB and cell may be obtained by paging, registration, or other methods. NR Enhanced Cell ID (NR E-CID) positioning refers to techniques which use additional UE measurements and/or NR radio resource and other measurements to improve the UE location estimate using NR signals. Although NR E-CID positioning may utilize some of the same measurements as the measurement control system in the RRC protocol, the UE generally is not expected to make additional measurements for the sole purpose of positioning; e.g., the positioning procedures do not supply a measurement configuration or measurement control message, and the UE reports the measurements that it has available rather than being required to take additional measurement actions.

UL TDOA positioning methods make use of the UL TDOA (and optionally UL SRS-RSRP) at multiple receive points (RPs) of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

UL AoA positioning methods make use of the measured azimuth and the zenith of arrival at multiple RPs of uplink signals transmitted from UE. The RPs measure A-AoA and Z-AoA of the received signals using assistance data received from the positioning server, and the resulting measurements are used along with other configuration information to estimate the location of the UE.

RAT-Independent positioning techniques can also be implemented, including [TS38.305]:

Network-assisted Global Navigation Satellite System (GNSS) methods: These methods make use of UEs that are equipped with radio receivers capable of receiving GNSS signals. In 3GPP specifications the term GNSS encompasses both global and regional/augmentation navigation satellite systems. Examples of global navigation satellite systems include Global Positioning System (GPS), Modernized GPS, Galileo, GLONASS, and BeiDou Navigation Satellite System (BDS). Regional navigation satellite systems include Quasi Zenith Satellite System (QZSS) while some augmentation systems are classified under the generic term of Space Based Augmentation Systems (SBAS) and provide regional augmentation services. In this concept, different GNSSs (e.g. GPS, Galileo, etc.) can be used separately or in combination to determine the location of a UE.

Barometric pressure sensor positioning: The barometric pressure sensor method makes use of barometric sensors to determine the vertical component of the position of the UE. The UE measures barometric pressure, optionally aided by assistance data, to calculate the vertical component of its location or to send measurements to the positioning server for position calculation. This method can be combined with other positioning methods to determine the 3D position of the UE.

Wireless Local Area Network (WLAN) positioning: The WLAN positioning method makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Alternatively, the UE makes use of WLAN measurements and optionally WLAN AP assistance data provided by the positioning server to determine its location.

Bluetooth positioning: The Bluetooth positioning method makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g. WLAN) to improve positioning accuracy of the UE.

TBS positioning: A TBS consists of a network of ground-based transmitters, broadcasting signals only for positioning purposes. The current type of TBS positioning signals are the MBS (Metropolitan Beacon System) signals and PRS (Technical Specification (TS) 36.211 [4]). The UE measures received TBS signals, optionally aided by assistance data, to calculate its location or to send measurements to the positioning server for position calculation.

Motion sensor positioning: The motion sensor method makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method can be used with other positioning methods for hybrid positioning.

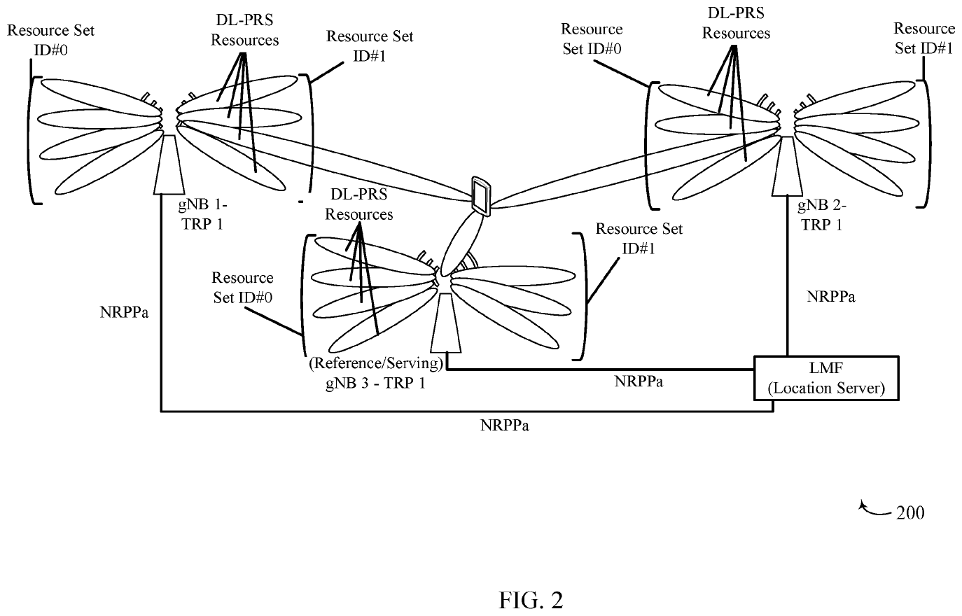

FIG. 2 illustrates a system 200 in which positioning reference signals can be utilized to obtain positioning measurements. For instance, PRS can be transmitted by different base stations (serving and neighboring) using narrow beams over FR1 and FR2, which is relatively different when compared to LTE where the PRS was transmitted across the whole cell. The PRS can be locally associated with a PRS Resource ID and Resource Set ID for a base station (TRP). Similarly, UE positioning measurements such as Reference Signal Time Difference (RSTD) and PRS RSRP measurements are made between beams (e.g., between a different pair of DL PRS resources or DL PRS resource sets) as opposed to different cells as was the case in LTE. In addition, there are additional UL positioning methods for the network to exploit in order to compute the target UE's location.

Table 2 and Table 3 show the reference signal to measurements mapping required for each of the supported RAT-dependent positioning techniques at the UE and gNB, respectively. RAT-dependent positioning techniques involve the 3GPP RAT and core network entities to perform the position estimation of the UE, which are differentiated from RAT-independent positioning techniques which rely on GNSS, Inertial Measurement Unit (IMU) sensor, WLAN and Bluetooth technologies for performing target device (UE) positioning.

TABLE 2
UE Measurements to enable RAT-dependent
positioning techniques

| | | To facilitate support |
|---|---|---|
| DL/UL Reference | | of the following |
| Signals | UE Measurements | positioning techniques |
| Rel. 16 DL PRS | DL RSTD | DL-TDOA |
| Rel. 16 DL PRS | DL PRS RSRP | DL-TDOA, DL-AoD, |
| | | Multi-RTT |
| Rel. 16 DL PRS/Rel. 16 | UE Rx-Tx time | Multi-RTT |
| SRS for positioning | difference | |
| Rel. 15 SSB/CSI-RS for | SS-RSRP(RSRP for | E-CID |
| Radio Resource | RRM), SS-RSRQ(for | |
| Management (RRM) | RRM), CSI-RSRP (for | |
| | RRM), CSI-RSRQ (for | |
| | RRM), SS-RSRP (for | |
| | RRM) | |

TABLE 3
gNB Measurements to enable RAT-
dependent positioning techniques

| | | To facilitate support |
|---|---|---|
| | gNB | of the following |
| DL/UL Reference Signals | Measurements | positioning techniques |
| Rel. 16 SRS for positioning | UL RTOA | UL-TDOA |
| Rel. 16 SRS for positioning | UL SRS-RSRP | UL-TDOA, UL-AoA, |
| | | Multi-RTT |
| Rel. 16 SRS for positioning, | gNB Rx-Tx time | Multi-RTT |
| Rel. 16 DL PRS | difference | |
| Rel. 16 SRS for positioning | AoA and ZoA | UL-AoA, Multi-RTT |

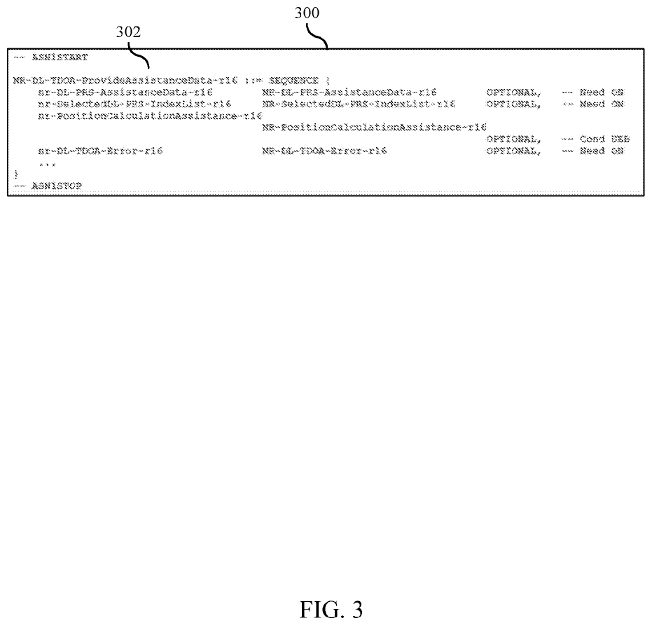

FIG. 3 illustrates an example of assistance data configuration 300 (implementation Rel-16 TS38.215), with respect to UE measurement and report configuration signaling applicable to downlink-based positioning techniques. In the DL-TDOA assistance data, the information element (IE) NR-DL-TDOA-ProvideAssistanceData 302 can be used by the location server to provide assistance data to enable UE-assisted and UE-based NR DL-TDOA, and may also be used to provide a NR DL-TDOA positioning specific error reason.

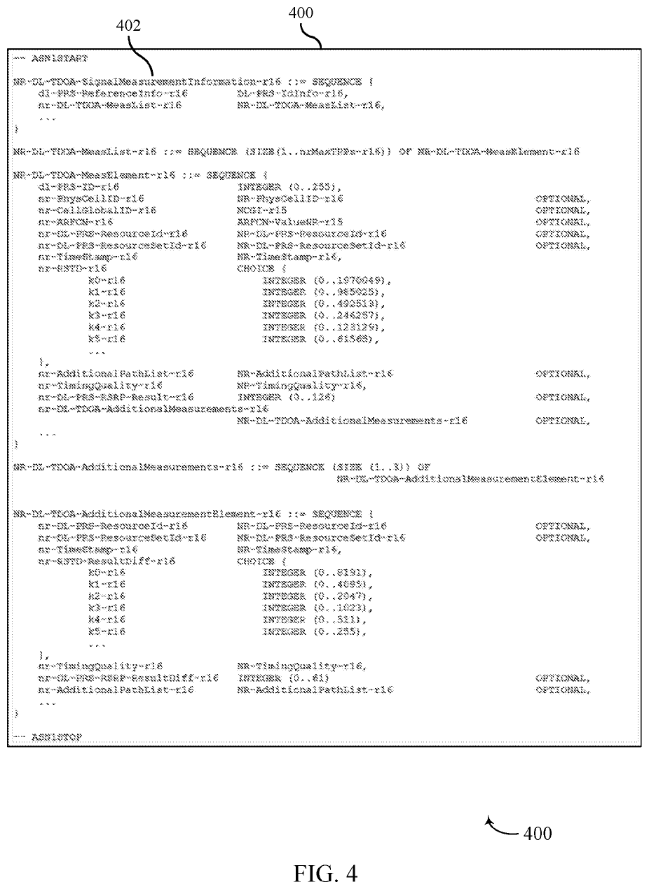

FIG. 4 illustrates an example of a positioning measurement report 400 (current implementation Rel-16). The UE measurement and report configuration includes signaling applicable to downlink-based positioning techniques. In the DL-TDOA measurement report, the IE NR-DL-TDOA-SignalMeasurementInformation 402 is used by the target UE to provide NR DL-TDOA measurements to the location server. The measurements are provided as a list of TRPs, where the first TRP in the list is used as reference TRP in case RSTD measurements are reported. The first TRP in the list may or may not be the reference TRP indicated in the NR-DL-PRS-AssistanceData. Furthermore, the target UE selects a reference resource per the TRP, and compiles the measurements per the TRP based on the selected reference resource.

The different downlink measurements, including downlink PRS RSRP, downlink RSTD, and UE Rx-Tx time difference required for the supported RAT-dependent positioning techniques are shown in Table 4. The measurement configurations may include four (4) pair of downlink RSTD measurements performed per pair of cells, and each measurement is performed between a different pair of downlink PRS resources or resource sets with a single reference timing; and eight (8) downlink PRS reference signal received power (RSRP) measurements can be performed on different downlink PRS resources from the same cell.

TABLE 4
Downlink measurements for downlink-based positioning techniques.
DL PRS RSRP

| | |
|---|---|
| Definition | DL PRS-RSRP, is the linear average over the power contributions (in [W]) of |
| | the resource elements that carry DL PRS reference signals configured for |
| | RSRP measurements within the considered measurement frequency |
| | bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than |
| | the corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe |
| | received from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for T_{UE-TX} |
| | measurement shall be the Tx antenna connector of the UE. For frequency |
| | range 2, the reference point for T_{UE-RX} measurement shall be the Rx antenna of |
| | the UE and the reference point for T_{UE-TX} measurement shall be the Tx antenna |
| | of the UE. |
| Applicable for | RRC_CONNECTED intra-frequency |
| | RRC_CONNECTED inter-frequency |

To comply with regulatory requirements, a network may be configured to enforce that a selected Public Land Mobile Network (PLMN) is allowed to operate in the country of the UE location by verifying the UE location during Mobility Management and Session Management procedures. In this case, when the AMF receives a Next Generation Application Protocol (NGAP) message containing User Location Information for a UE using NR satellite access, the AMF may decide to verify the UE location. If the AMF determines based on the Selected PLMN ID and User Location Information (ULI) (including Cell ID) received from the gNB that it is not allowed to operate at the present UE location the AMF may reject the request and inform the UE of the country of the UE location.

If the AMF, based on the ULI, is not aware of the UE location with sufficient accuracy to make a final decision, the AMF proceeds with the Mobility Management or Session Management procedure and may initiate UE location procedure, as specified in clause 6.10.1 of TS 23.273 [87], to determine the UE location. In case of a NAS procedure, the AMF may either reject any NAS request targeted towards a PLMN that is not allowed to operate at the known UE location and indicate a suitable Cause value and, if known in AMF, the country of the UE location, or accept the NAS procedure and later deregister the UE once the UE location is known.

In the case of a handover procedure, if the (target) AMF determines that it is not allowed to operate at the current UE location, the AMF either rejects the handover, or accepts the handover and later deregisters the UE.

Network selection for NR satellite access: Network selection principles specified in clause 5.2.2 may also for NR satellite access. For NR satellite access, a UE with location capability may use its awareness of its location to select a PLMN that is allowed to operate in the country of the UE location as specified in TS 23.122 [17]. To comply with regulatory requirements, the network may be configured to enforce this UE choice by verifying the UE location, as described in clause 5.4.11.4.

Support of Mobility Registration Update: A radio cell for NR satellite access may indicate support for one or more TACs for each PLMN. A UE that is registered with a PLMN may access a radio cell and does not need to perform a Mobility Registration Update procedure as long as at least one supported Tracking Area Code (TAC) for the Registered Public Land Mobile Network (RPLMN) or equivalent to the RPLMN is part of the UE Registration Area. A UE can perform a Mobility Registration Update procedure when accessing a radio cell where none of the supported TACs for the RPLMN or equivalent to the RPLMN are part of the UE Registration Area.

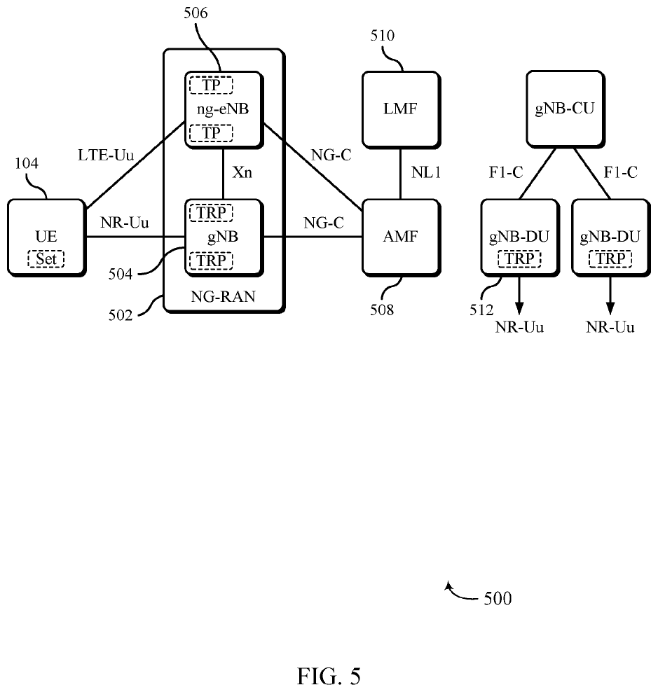

FIG. 5 illustrates an example architecture 500 applicable to NG-RAN 502 for UE positioning. The NG-RAN 502 is capable of supporting both types of interfaces LTE-Uu and NR-Uu, and the gNB 504 may be implemented in an NTN architecture. The gNB 504 and an LTE next generation evolved NodeB (ng-eNB) 506 are connected by a Xn backhaul interface. The access and mobility management function (AMF) 508 may be transparent, or bypassed in an NTN architecture, and the LMF 510 provides the positioning techniques and configuration for UE positioning.

The AMF 508 may receive a request for some location service associated with a particular target UE 104 from another entity (e.g., a gateway mobile location center (GMLC) or UE), or the AMF itself decides to initiate some location service on behalf of a particular target UE, such as for an Internet Protocol (IP) multimedia subsystem (IMS) emergency call from the UE. The AMF 508 then sends a location services request to the LMF 510. The LMF 510 processes the location services request which may include transferring assistance data to the target UE 104 to assist with UE-based and/or UE-assisted positioning and/or may include positioning of the target UE. The LMF 510 then returns the result of the location service back to the AMF 508 (e.g., a position estimate for the UE 104). In the case of a location service requested by an entity other than the AMF (e.g., requested by a GMLC or UE), the AMF 508 returns the location service result to this entity.

An NG-RAN node may control several TRPs and/or TPs, such as remote radio heads, or downlink PRS-only TPs for support of PRS-based terrestrial beacon system (TBS). A LMF 510 may have a proprietary signaling connection to an enhanced serving mobile location center (E-SMLC), which may enable the LMF 510 to access information from an evolved universal terrestrial radio access network (E-UTRAN) (e.g. to support the observed time difference of arrival (OTDOA) for a Evolved Universal Terrestrial Radio Access (E-UTRA) positioning method using downlink measurements obtained by a target UE of signals from next generation evolved NodeBs (ng-eNBs) and/or PRS-only TPs in E-UTRAN). A LMF 510 may have a proprietary signaling connection to a SUPL location platform (SLP). The SLP is the secure user plane location (SUPL) entity responsible for positioning over the user plane. In the case of a split gNB architecture, a gNB-distributed unit (DU) 512 may include TRP functionality, where the TRP functionality may support functions for a Transmit Point (TP), RP, or both. A gNB-DU 512 that includes TRP functionality does not need to offer cell services. To support positioning of a target UE and delivery of location assistance data to a UE with NG-RAN access in 5GS, location related functions are distributed as shown in the example architecture 500.

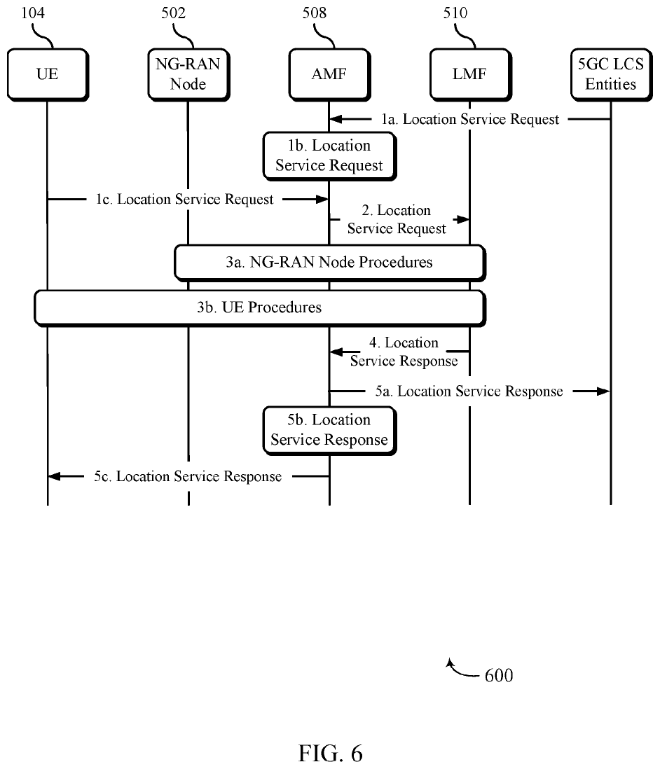

FIG. 6 illustrates an overall sequence 600 of signaling events applicable to the UE 104, the NG-RAN 502, the AMF 508, and the LMF 510 for any location service. When the AMF 508 receives a location service request (LSR), and the UE 104 is in a connection management (CM)-idle state (CM-IDLE) state, the AMF 508 performs a network triggered service request in order to establish a signaling connection with the UE and assigns a specific serving gNB or next generation evolved NodeB (ng-eNB). The UE is assumed to be in a connected mode before the beginning of the signaling shown in the figure (e.g., signaling that may be needed to bring the UE to the connected mode prior to step 1a is not shown). However, the signaling connection may be later released, such as by the NG-RAN 502 node as a result of signaling and data inactivity while positioning is still ongoing. Additionally, the NG-RAN 502 node represents any combination of NTSs in an NTN, including a network architecture with a Terrestrial Network (TN) and NTN gNB, and/or a network architecture that is fully an NTN with NG-RAN architecture.

At step 1, either step 1a, step 1b, or step 1c is performed. At step 1a, an entity in the 5GC, such as a GMLC, requests a location service for positioning a target UE 104 to the serving AMF 508. Alternatively at step 1b, the serving AMF 508 for the target UE 104 determines the need for a location service (e.g. to locate the UE for an emergency call). Alternatively at step 1c, the UE 104 requests a location service, such as for the positioning or delivery of assistance data, to the serving AMF 508 at the non-access-stratum (NAS) level.

At step 2, the AMF 508 transfers the location service request to the LMF 510. At step 3a, the LMF 510 instigates location procedures with the serving and possibly neighboring next generation evolved NodeB (ng-eNB) or gNB in the NG-RAN 502, such as to obtain positioning measurements or assistance data. In addition to step 3a or alternatively (instead of step 3a), at step 3b, the LMF 510 instigates location procedures with the UE 104, such as to obtain a location estimate or positioning measurements, or to transfer location assistance data to the UE.

At step 4, the LMF 510 provides a location service response to the AMF 508 and includes any needed results, such as a success or failure indication and, if requested and obtained, a location estimate for the UE 104. At step 5a (if step 1a was performed), the AMF 508 returns a location service response to the 5GC entity in step 1a and includes any needed results, such as a location estimate for the UE 104. At step 5b (if step 1b occurred), the AMF 508 uses the location service response received in step 4 to assist the service that triggered this in step 1b, such as to provide a location estimate associated with an emergency call to a GMLC. At step 5c (if step 1c was performed), the AMF 508 returns a location service response to the UE 104 and includes any needed results, such as a location estimate for the UE.

In aspects of positioning in an NTN, the location procedures applicable to NG-RAN occur in steps 3a and 3b, which supports the configurations and reporting for communication between the LMF 510 and the UE 104 to enable NTN system level positioning. The steps 3a and 3b may involve the use of different positioning methods (also referred to herein as positioning techniques or positioning procedures) to obtain location related measurements for a target UE, and from these, the UE computes a location estimate and additional positioning assistance information.

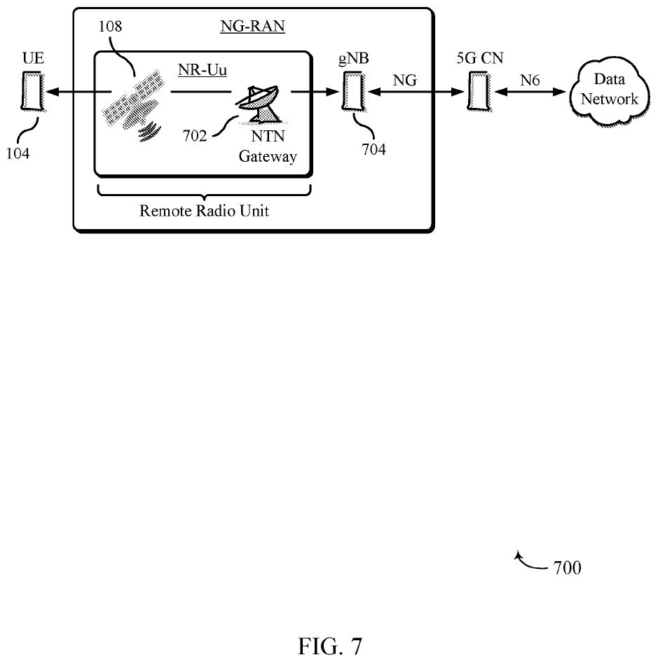

FIG. 7 illustrates a transparent satellite-based NG-RAN architecture 700. The satellite payload implements frequency conversion and a radio frequency amplifier in both the uplink and downlink directions, and it corresponds to an analogue RF repeater. Hence, the satellite (e.g., a network entity 102) repeats the NR-Uu radio interface from the feeder link, between the NTN gateway 702 and the satellite, to the service link between the satellite and the UE 104 (and vice-versa). The satellite radio interface (SRI) on the feeder link is the NR-Uu, meaning that the satellite does not terminate the NR-Uu radio interface. The NTN gateway 702 may support all of the necessary functions to forward the signal of the NR-Uu interface, and different transparent satellites may be connected to the same gNB 704 on the ground. Note that while several gNBs may access a single satellite payload, the illustration and description is simplified to the one gNB 704 accessing the satellite payload, without loss of generality.

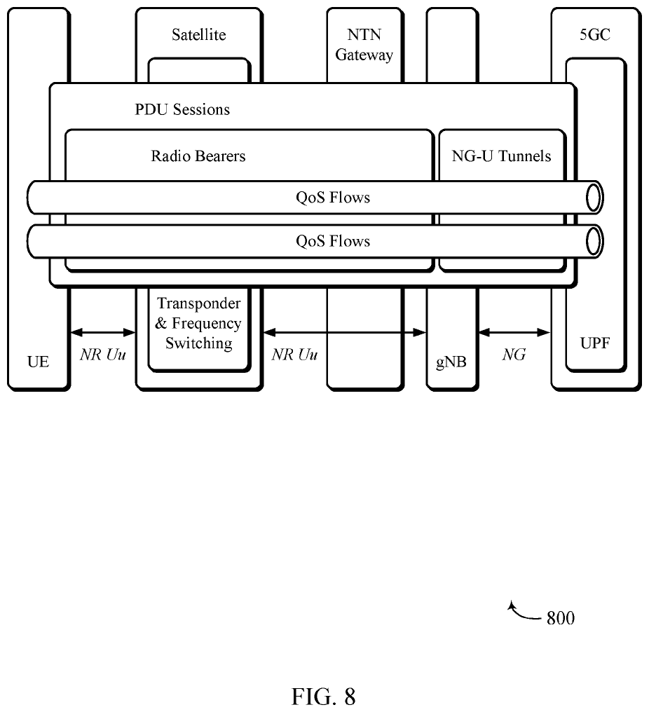

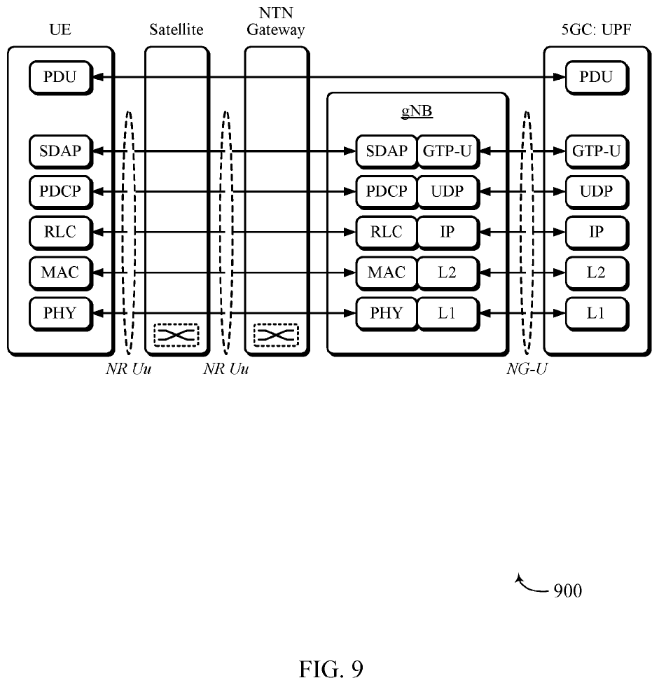

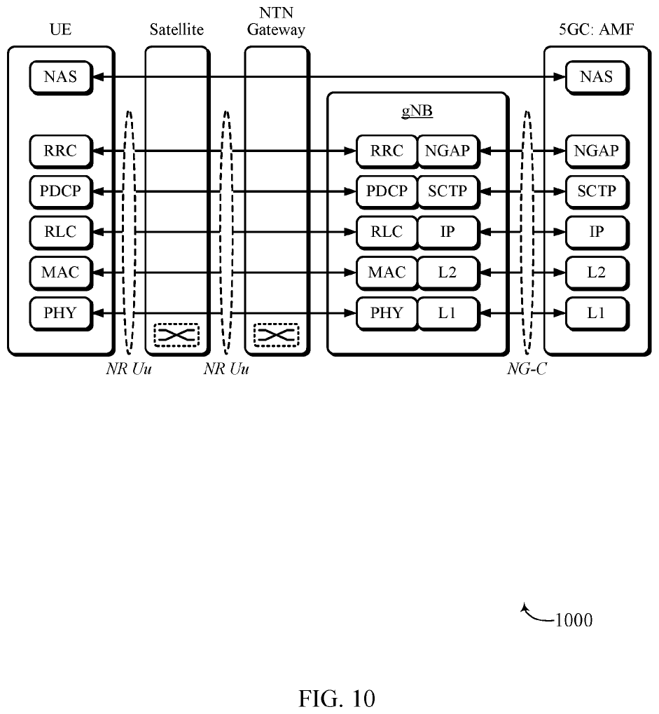

FIG. 8 illustrates an example 800 of a transparent satellite-based NG-RAN architecture with mapping to quality of service (QoS) flows. The UE 104 has access to the 5G system via a 3GPP NR-based radio interface. FIG. 9 illustrates an example 900 of the UE user plane protocol stack for the transparent satellite-based NG-RAN architecture. The user data is transported between the UE 104 and the 5GC via the NTN gateway. FIG. 10 illustrates an example 1000 of the control plane protocol stack for the transparent satellite-based NG-RAN architecture. The non-access stratum (NAS) Session Management (NAS-SM) and NAS-Mobility Management (MM)) signaling from the UE 104 and the NG-AP signaling from the gNB are transported toward the 5GC and vice-versa.

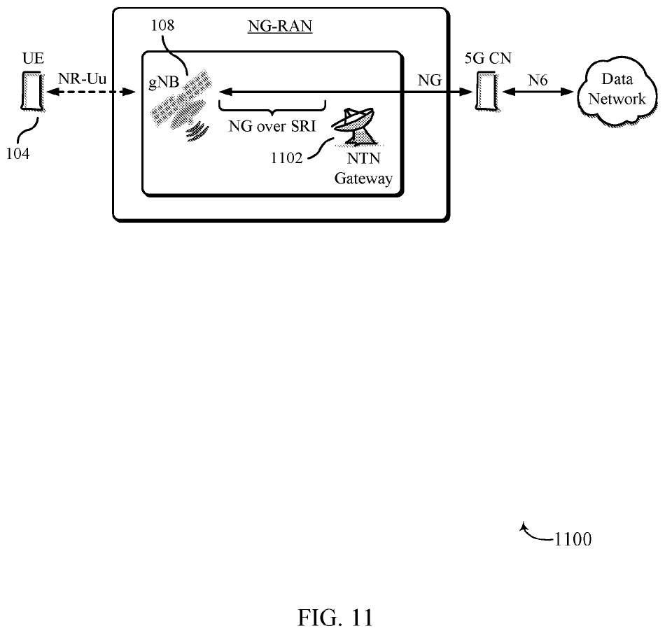

FIG. 11 illustrates a regenerative satellite-based NG-RAN architecture 1100, such as a regenerative satellite without an inter-satellite link (ISL), and with a gNB-processed payload. The NG-RAN logical architecture may be used as baseline for an NTN. The satellite payload implements regeneration of the signals received from ground-based network nodes. In this architecture 1100, the NR-Uu radio interface is implemented on the service link between the UE 104 and the satellite (e.g., a network entity 102), and the satellite radio interface (SRI) is implemented on the feeder link between the NTN gateway 1102 and the satellite. The satellite radio interface (SRI) is a transport link between the NTN gateway 1102 and the satellite.

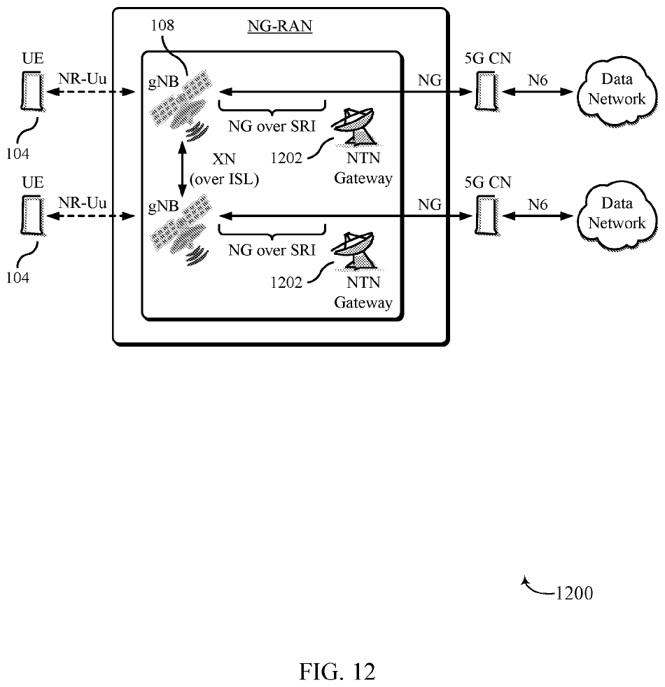

FIG. 12 illustrates another example of a regenerative satellite-based NG-RAN architecture 1200, such as a regenerative satellite system with an ISL. The ISL is a transport link, such as a radio interface or an optical interface, between satellites (e.g., network entities 102). The NTN gateway 1202 is a transport network layer node, and supports all necessary transport protocols. In this architecture 1200, a UE 104 that is served by a gNB onboard a satellite could access the 5GCN via the ISL. In implementations, the gNB onboard different satellites may be connected to the same 5GCN on the ground, and if a satellite hosts more than one gNB, the same satellite radio interface (SRI) may be used to transport all the corresponding NG interface instances. In this architecture, the protocol stack of the satellite radio interface (SRI) is used to transport the UE user plane between a satellite and an NTN gateway 1202. The user protocol data units (PDUs) are transported over General Packet Radio Service (GPRS) Tunneling Protocol (GTP) GTP-U tunnels between the 5GCN and the onboard gNB, via the NTN gateway 1202. The NG-AP is transported over Stream Control Transmission Protocol (SCTP), between the 5GCN and the onboard gNB via the NTN gateway. The NAS protocol is also transported by the NG-AP protocol, between the 5GCN and the onboard gNB, via the NTN gateway.

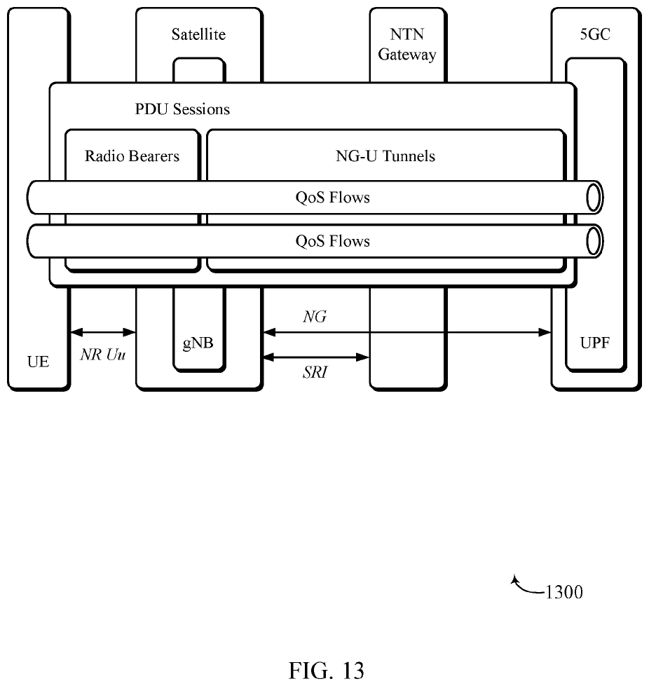

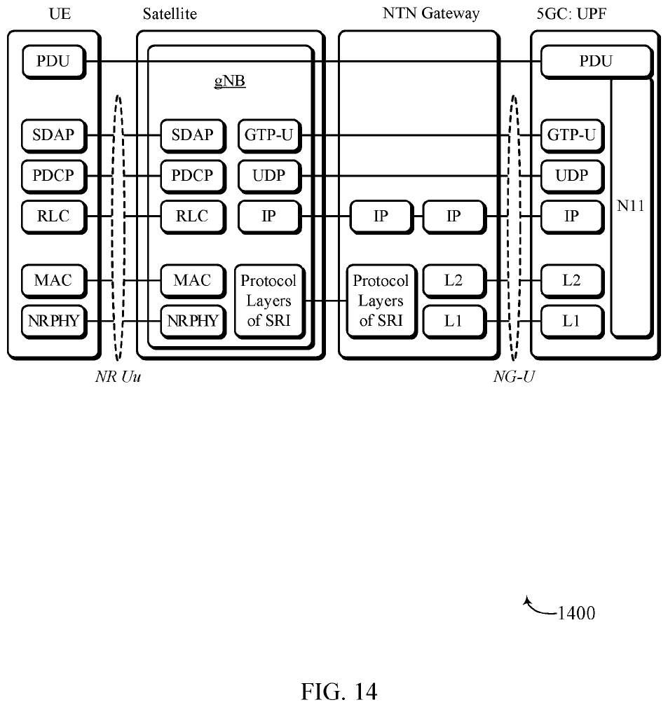

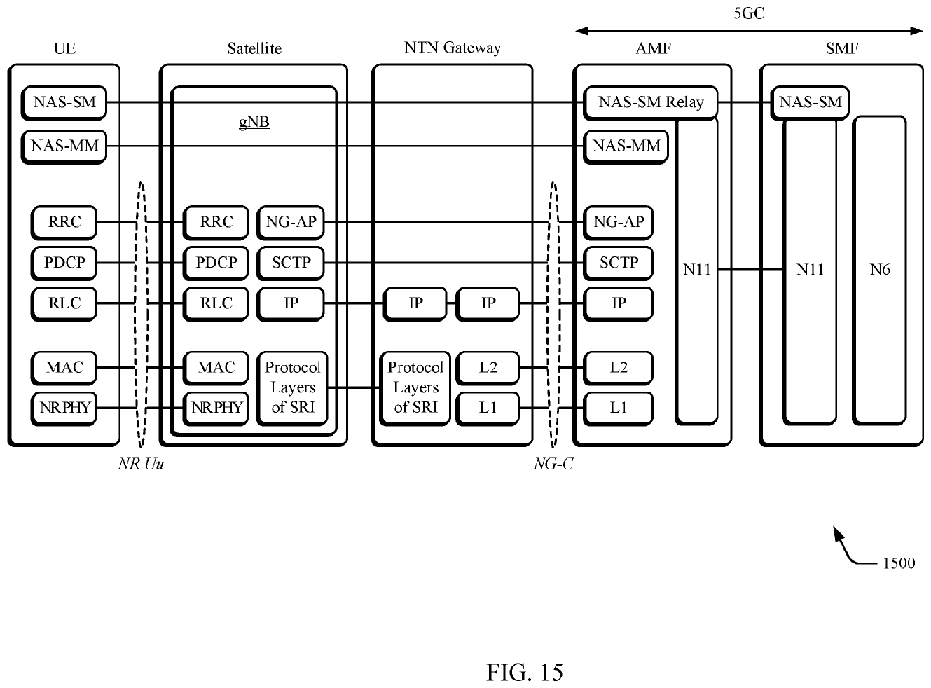

FIG. 13 illustrates an example 1300 of a regenerative satellite-based NG-RAN architecture with gNB onboard, and the quality of service (QoS) flows. FIG. 14 illustrates an example 1400 of the UE user plane protocol stack for a PDUsession, with respect to the regenerative satellite-based NG-RAN architecture with the gNB onboard. The protocol stack of the satellite radio interface (SRI) is used to transport the UE user plane between the satellite and the NTN gateway. The user protocol data units (PDUs) are transported over GTP-U tunnels between the 5GC and the onboard gNB, via the NTN gateway. FIG. 15 illustrates an example 1500 of the UE control plane protocol stack for a PDU session, with respect to the regenerative satellite-based NG-RAN architecture with the gNB onboard. The NG-AP is transported over SCTP, between the 5GC and the onboard gNB, via the NTN gateway. The non-access stratum (NAS) protocol is also transported by the NG-AP protocol, between the 5GC and the onboard gNB, via the NTN gateway.

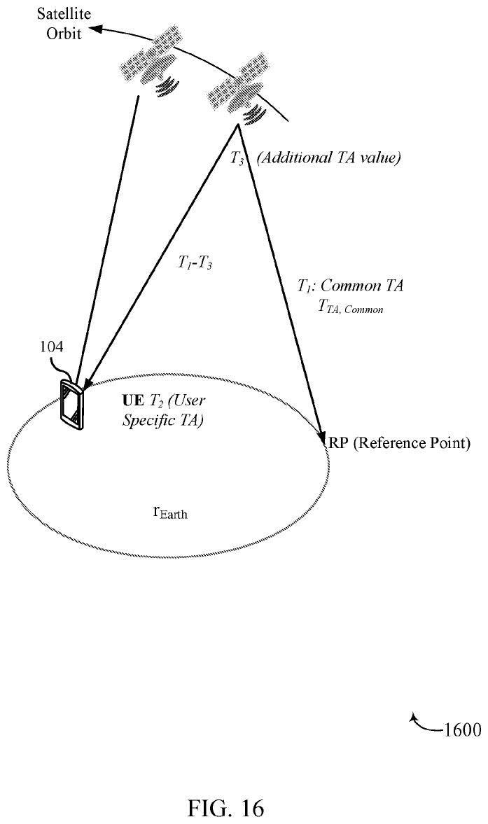

FIG. 16 illustrates an example 1600 of open loop TA in NTN. An open loop TA methodology can be adopted for non-terrestrial networks with transparent payload architectures, where the TA may be divided into two parts, e.g., common TA and user specific TA. Common TA can be defined as the network controlled beam and/or cell specific common TA and may include timing offset utilized by the network and that is common for users in one cell. UE-specific TA is the UE self-estimated TA to pre-compensate for the service link delay, as shown in the example 1600.

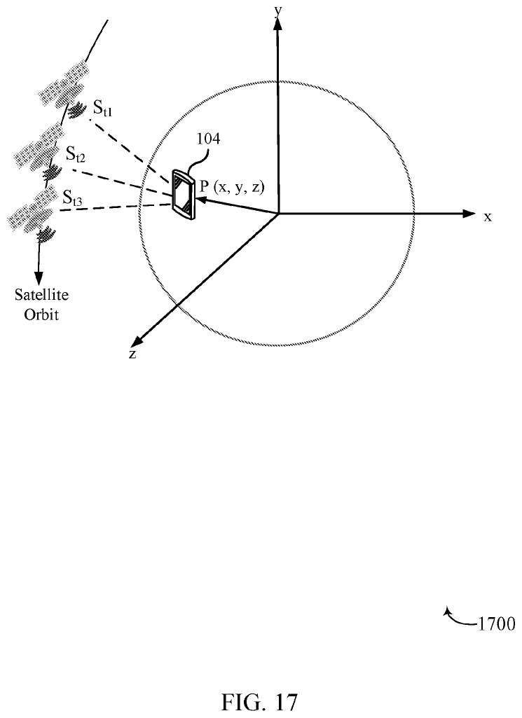

FIG. 17 illustrates an example 1700 where TA measurements at multiple (e.g., three) time instances may be performed. For instance, if one way propagation delay from satellite to a UE 104 at three points in space is known, the UE location estimate may be calculated by transforming delays into distances as (d=τ/c, where c is the speed of light). In the example 1600, considering that Non-Geostationary-Satellite Orbit (NGSO) satellites are moving with respect to UEs, the TA measurements at three time instances may be performed. In other implementations, time instances greater than 3 may also be configured, which may increase the accuracy of the distances. The intersection of three distances may correspond to the UE location. Hence, a positioning method based on TA calculation in NTN may be formulated that can either be applied to a single satellite or may be based on TA calculation from multiple satellites.

In implementations, assistance data configuration is provided for enabling TA-based positioning methods together with the associated capability exchange procedures from a location server (e.g., LMF) to an NG-RAN node and target user for TA positioning methods. Further, the present disclosure discusses measurement configuration and reporting procedures for calculating the TA-based UE position for both single and multiple satellite scenarios. In implementations, a TA-based positioning method can be implemented through NG-RAN node and/or directly through location server. Thus, measurement configuration and reporting procedures can apply either to LTE Positioning Protocol (LPP) and/or NRPPa protocols that are discussed in the disclosure.

This disclosure also provides signaling aspects for TA-based positioning procedures, such as for positioning procedures to implement TA positioning methods. For instance, capability exchange procedures are provided from a location server to a NG-RAN node and a target user. Parameter configuration aspects are also provided for performing TA measurements for single and multiple satellites cases.

Implementations discussed in this disclosure may be implemented separately or in combination with each other to support NR TA-based positioning using the supported NTN interfaces and network entities/nodes. Further, for the purposes of this disclosure, a positioning-related reference signal may be referred to as a reference signal used for positioning procedures and/or purposes to estimate a target-UE's location (e.g., PRS) and/or based on existing reference signals such as channel state information reference signal (CSI-RS) or SRS. Further, a target UE may be referred to as a device and/or entity to be localized and/or positioned. In various implementations, the term ‘PRS’ may refer to a signal such as a reference signal, which may or may not be used primarily for positioning. Further, a target UE may be referred to as a UE, device, and/or entity of interest whose position is to be obtained by the network and/or by the UE itself.

In implementations of this disclosure, TA positioning measurement and reporting procedures are provided. For instance, a target UE is configured by a location server using LPP to perform TA positioning measurements, and the target UE can perform such measurements based on configured resources and report the measurements to the location server. The measurements, for example, may correspond to a single satellite node or for multiple satellite nodes. Further, the TA-based measurement configuration can include parameters and associated behavior to enable a reporting mechanism specified by a positioning calculation entity, e.g., LMF.

In implementations, a location server explicitly requests TA-based location measurement data and/or a TA-based location estimate from the target UE using request/provide location information messages. For instance, the location server (e.g., LMF) may send a RequestLocationInformation LPP message to the target UE indicating what type of measurements and location related data may be included the UE's location information report. Accordingly, a TA location information request IE may be formulated that contains information regarding the location information report. In at least one example the IE (e.g., TA-RequestLocationInformation) may request following information in its report:
location estimates
type of reporting, e.g., immediate reporting, one shot, periodic, event-based reporting, scheduled reporting in advance or for future time instance, etc.
location reporting format
TA estimates, e.g., common TAs and/or user-specific TAs
Time stamps
Distance calculation
UE location method for user-specific TA calculation

In implementations, a location server may request the reporting of measurements of a target UE's computed TA. In response to a location information request, the target UE can report TA positioning location measurements and/or location estimates to the location server via LPP, e.g., via exchanging a ProvideLocationInformation LPP message. This message may contain information that is requested by the location server in RequestLocationInformation LPP message and/or additional information that is relevant to a target UE. In at least one example, the report may contain following parameters and/or fields:
Reference signal information: information regarding the reference signals on which measurements are performed. For example, if PRS are used, then information about PRS ID and PRS resource ID can be used to identify a DL-PRS resource. If another RS or signal type is used, then the corresponding ID information identifying the measurement of that resource may be signaled.
Cell measurement elements: Parameters related to cell can also be included in the report. For example, parameters such as physical cell ID, TRP ID, and Cell global ID may be part of information in the report.
Neighboring cell measurement elements: In scenarios where measurements are performed, then information regarding a neighbor cell such as physical cell ID of neighbor cell, bandwidth part (BWP), and polarization information may be included in the report.
TA measurements: The target UE may indicate the TA measurements including TA-common measurements, user-specific TA measurements, and/or differential TA measurements. In scenarios where multiple measurements are performed at different time instances, then multiple measurements with corresponding time stamps may be included in the report. Information regarding the validity duration of the measurements may also be part of the report.
Time stamp: A time stamp may be included indicating an association with a time instance at which the TA measurement is performed. One or more time stamps may be reported.
Ephemeris information: Ephemeris information on which user-specific TA is calculated at one or multiple time instances may also be part of report.
Distance calculation: The target UE may calculate the distance between its position and satellite position at one or multiple time instances, e.g., according to UE configuration. In such scenarios, distances calculated at one or multiple time instances may be included in the report, and a corresponding time stamp may also be indicated.
Location estimates: The target user may also report its location estimates in a configured format (e.g., latitude and longitude) and/or using one or more geographic shapes such as Ellipsoid Point, Ellipsoid Point with uncertainty Circle, Ellipsoid Point with uncertainty Ellipse, High Accuracy Ellipsoid point with uncertainty ellipse, Polygon, Ellipsoid Point with Altitude, Ellipsoid Point with altitude and uncertainty ellipsoid, High Accuracy Ellipsoid point with altitude and uncertainty ellipsoid, Ellipsoid Arc, or combinations thereof.
UE location method for user-specific TA calculation: Information regarding the type of RAT-independent method employed for user-specific TA calculation may also be included in the location information report.

In implementations, a target UE transfers location measurement data and/or a location estimate to the location server even in the absence of a request. In implementations, the location server may also configure a response time to the target UE in the request message, during which the location server expects a response message of a TA measurement report. In scenarios of TA-based location estimates for a single satellite node, the response time can at least include the configured measurement window (e.g., in which the target UE calculated TA estimates, distance, and/or location for multiple time instances) and the propagation delay time between the target UE and location server. In at least one implementation, if a target UE cannot perform an entire group of measurements during the response time, the target UE may reduce the number of measurements in order to adhere to the configured time response of the report.

In implementations, the target UE is configured with resources on multiple satellite nodes and is configured to perform measurements on multiple satellite nodes. The multi-satellite measurement configuration, for instance, is indicated in the assistance data configuration and/or in measurement and reporting messages, e.g., a RequestLocationInformation message. In such scenarios, the target UE can perform measurements on resources from different satellite nodes, and the target UE may be configured to send a separate measurement report for each of the satellite node measurements or one consolidated report indicating measurements from each satellite node. In some scenarios, one satellite node may act as serving reference cell while other information from other satellite nodes may be regarded as a neighboring cell. In at least one implementation, when a single report contains information about measurements from different satellite nodes (e.g., TRPs), the target device would explicitly indicate in its report which measurements are related to which satellite node (e.g., TRP). For example, an IE (e.g., TA-SignalMeasurementInformation) may be used that contains measurements corresponding to serving reference cell and neighboring cell. In at least some implementations, when a resource is configured for a TA measurement corresponding with a cell, the resource may be punctured in the other (e.g., neighboring) cells.

In implementations, when measurements for each satellite node of multiple satellite nodes are to be reported back in separate messages and/or measurement reports are more than a specified number of satellite nodes that can be allocated in one message, the location server may explicitly allow additional location information messages. In such scenarios, the target device may send additional ProvideLocationInformation messages to the server, where the last message may include the endTransaction IE set to TRUE indicating that this is last message.

Implementations described in this disclosure also provide for error handling and abort procedures for TA-based positioning. For instance, a target UE and/or location server initiates a LPP error and/or abort message when it receives erroneous and/or unexpected data or detects that certain data are missing to perform a task for TA positioning. For instance, a target UE receives a RequestLocationInformation message from a location server, and upon reception, the target UE checks that the requested information is compatible with the target device capabilities and configuration, e.g., a UE location estimated method to calculate user-specific TA is no longer available. If the target UE does not support such capability, the target UE can generate an LPP error message. Upon reception of error message, the location server can abort the ongoing procedure or provide the specified information.

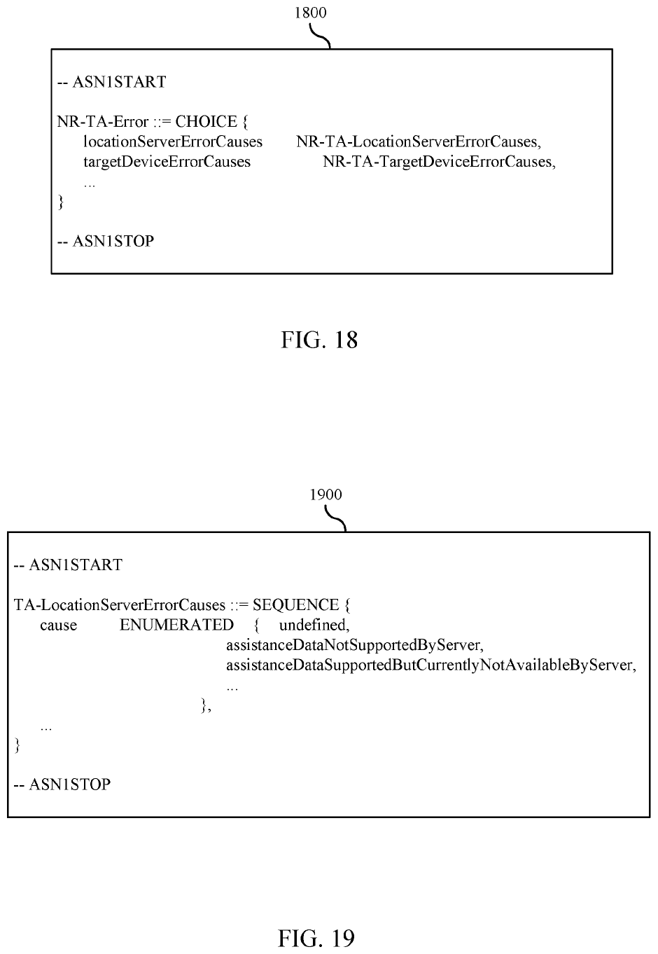

FIG. 18 depicts an example error IE 1800 that supports TA for positioning in accordance with aspects of the present disclosure. In at least one implementation, the error IE 1800 (e.g., TA-Error) may be used by the location server and/or target device to provide TA error reasons to the target UE and/or location server, respectively.

FIG. 19 depicts an example error IE 1900 that supports TA for positioning in accordance with aspects of the present disclosure. In implementations the TA-Location ServerErrorCauses IE (e.g., the error IE 1900) can be used by the location server to provide causes for TA error to the target UE, whereas TA-TargetDeviceErrorCauses IE can be used by target UE to explain TA error reasons to location server.

In implementations a target UE IE can also describe causes for error. For example, following list of events and/or reasons may generate an error message from the target UE:
Change of coverage area of a satellite
A location estimation method for UE specific TA calculation is not supported and/or is not available
Response time for a report is smaller than a threshold, e.g., the threshold being a propagation time plus a processing time.

Implementations described herein also provide for TA positioning measurement and reporting using NRPPa. For instance, NRPPa location information transfer procedures are used to handle the transfer of TA positioning measurement reports between an NTN NG-RAN Node and a location server (e.g., LMF), such as in scenarios where an NG-RAN-based TA positioning measurement and reporting procedure is implemented to estimate a TA-based target UE location estimate.

In implementations, a location server may request the reporting of TA measurements (e.g., TA common and/or user-specific TA) from a NG-RAN node. The NG-RAN node may be implemented as a gNB, gateway, satellite, or combination thereof. Based on the received TA measurement values and corresponding mapping parameters, the location server can compute the target user location. In at least one implementation, measurements for TA positioning can be performed by a NG-RAN node such as initiated by a location server, and measurements can be reported to the location server by NG-RAN node after receiving a request message from location server.

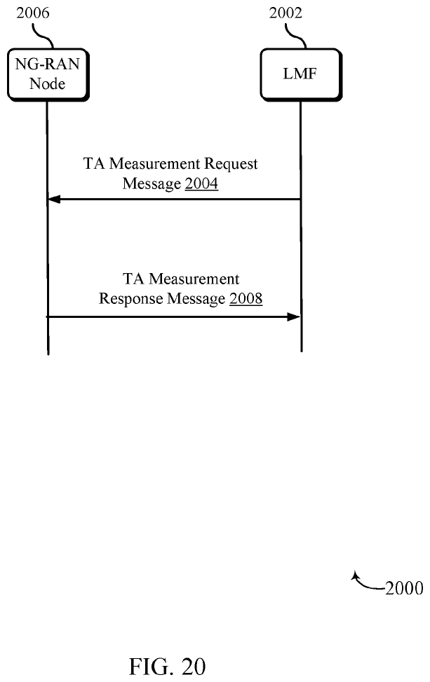

FIG. 20 depicts an example TA measurement procedure 2000 that supports TA for positioning in accordance with aspects of the present disclosure. The TA measurement procedure 2000, for instance, is implemented using NRPPa.

In the TA measurement procedure 2000, an LMF 2002 (e.g., location server) initiates the procedure by sending a TA measurement request message 2004 to an NG-RAN node 2006 (e.g., gNB). The TA measurement request message 2004 may contain information about type of TA measurements to be reported. The NG-RAN node 2006 receives the TA measurement request message 2004 and may reply to the LMF 2002 with a TA measurement response message 2008, e.g., if the NG-RAN node is able to initiate the requested TA measurements.

In implementations, information about a type of measurement reporting (e.g., as requested by location server) may be included in an IE, e.g., Report Characteristics IE. In at least one implementation, a location server may request a single measurement report, for example by setting a field in the Report Characteristics IE. In such scenarios and in at least one implementation, the NG-RAN node can either initiate a TA measurement response message to indicate that the TA measurement is supported, and then send separately a TA measurement report message that contains the specified TA measurements. In at least one implementation, the NG-RAN node may return the TA measurement results in the TA measurement response message 2008. In addition to TA calculations, the following information may also be included in the report message to translate the TA measurement results into positioning estimate:
Time stamp: time at which the TA measurements were calculated by UE
Ephemeris information: Satellite coordinates in a single or in multiple formats
Epoch time
Cell characteristics: Cell related parameters

In implementations, the location server may request that multiple TA measurements (e.g., the number of measurements may be indicated by a field) are to be reported in a single report, which may be indicated by a field. In such scenarios, a time window for the measurement report may also be set by the location server, e.g., and can be indicated in the request message. After receiving this type of information in the message, the NG-RAN node can initiate a TA response message to indicate to the location server that a measurement procedure has been started and TA calculations and corresponding parameters are to be sent by a measurement report message.

Upon completion of the TA measurement procedure, the NG-RAN node can send TA measurements along with addition information to the location server in the TA measurement report message. Additional information in the report message may include time stamps for each TA calculation, ephemeris information at each TA measurement, epoch time, and so forth. In at least one implementation, the NG-RAN node may request additional time in the response message, such as if the configured time window is too small to perform measurements. In at least one implementation, if the NG-RAN is not able to perform measurements in the indicated time window, the NG-RAN node may respond to the location server with a TA measurement failure message. The failure message may include an indication of the cause of failure, e.g., the time window being too small.

In implementations, the location server may request the NG-RAN node to perform periodic measurements and report back the measurement results. Such a request, for example, may be indicated by the location server in the configuration or reporting IE, e.g., in Report Characteristics IE. For instance, if the field in Report Characteristics IE is set to “Periodic,” the NG-RAN node may initiate the requested measurements and can reply with the first TA measurements in the TA measurement response message or can indicate that measurement reports will subsequently be sent. The NG-RAN node can periodically initiate the TA measurement report procedure for the measurements, such as with the requested reporting periodicity. In at least one implementation, the reporting periodicity period is set by the location server and the NG-RAN node terminates the measurement reporting after the expiry of the reporting periodicity period.

In at least one example, the location server explicitly indicates to the NG-RAN node in a separate message to terminate the periodic TA measurement reporting. Such implementations may be implemented by an LMF by generating a TA measurement termination command. In at least one implementation, each measurement report during this periodic period can correspond to one TA calculation at one time instance at one satellite position. Information about satellite position, epoch time, and TA calculations with time stamp can be part of each report. In at least one implementations, each periodic report may correspond to TA results for multiple time instances, where a time window may be defined by the location server that is to be associated with each report. Each report, for instance, may contain multiple TA measurements results calculated over a time (e.g., as defined by a time window) and repeated periodically.

In at least some implementations, a location server may request event-based report triggering and/or measurement reports at certain time instances in the future, which can be scheduled and/or defined based on a specified time instance. One or more time instances in the future may also be requested for reporting the TA-based measurements and/or location estimate. The NG-RAN node may respond with positioning measurement according to the event-based and/or the configured future time instance reporting.

In at least one implementation, a target UE sends user-specific TA information and/or differential TA information (e.g., with respect to previous transmitted TA information) to the NG-RAN node using one or more of uplink control information (UCI), uplink media access control control element (MAC-CE), RRC, physical uplink shared channel (PUSCH), or a combination thereof, and such behavior may be explicitly requested by the NG-RAN node and/or any network entity. In at least one implementation, the target UE autonomously sends (e.g., independent of a request from the NG-RAN node and/or other network entity) user-specific TA information and/or differential TA information (e.g., with respect to previously transmitted TA information) to the NG-RAN node.

Implementations also provide support for TA-assisted RAT-dependent positioning procedures. For instance, in implementations a RAT-dependent method such as NR E-CID may utilize TA measurements along with the RAT-dependent method's own measurements to assist and/or enhance the accuracy of the deployed positioning methods, where TA measurements may be included in a same and/or in a separate measurement report. For example, the TA measurements may be read with RSRP measurements in an NR E-CID method to increase the accuracy of the NR-CID method. This may be advantageous in NTN where the cell size can be large, and thus the accuracy of NR E-CID can be increased. The TA measurement information may be requested to an NG-RAN node by a location server using NRPPa and/or may be requested to a target UE by the location server using LPP. In at least one implementation, TA measurements are explicitly requested by the location server in the report configuration with a field indicating that the TA measurements are to be included in the RAT-dependent method report. In at least one implementation, the NG-RAN node and/or target UE implicitly include TA measurements in the positioning method report, where inclusion of the TA measurements may be based on a type of positioning method that is employed. For example, when NR E-CID method measurements are requested, the target UE and/or NG-RAN node may include the TA measurements in its report.

In implementations, assistance information that can translate and/or assist TA measurements (e.g., TA-common parameters and user-specific TA parameters) are also included in the report, where this information may or may not be explicitly requested by the location server. For example, this assistance information may include information about satellite ephemeris when the measurements are taken, time stamp when the measurements are taken, the type of reference signal on which measurements are done, etc.

In at least one implementation, when an NG-RAN node is configured by a location server to report the TA measurements along with its own method specific measurements (e.g., the measurements for the NR E-CID method), the NG-RAN node may initiate new TA measurements in scenarios where previous TA measurements are not available and/or are considered out of date. In such scenarios, the NG-RAN node may indicate to the location server that previous TA measurements are not available or are out of date, and new measurements will be provided in subsequent reports. In at least one implementation, the location server may also associate a time window for which TA measurements are to be provided, where this time window may be specific to TA measurements. In at least one example, when a time window is associated with other measurements (e.g., RSRP measurements for E-CID), the same time window may also be valid for TA measurements.

Implementations described in this disclosure also provide for TA-based positioning configuration and capability exchange for a single satellite. For instance, in implementations a location server exchanges TA positioning capabilities with a target UE and an NG-RAN node using LPP and NRPPa signaling. Based on the capabilities exchange information, location server can configure parameters to the target UE to calculate TA estimates and/or location estimates with reference to a single satellite at different orbital coordinates. In such scenarios, LPP can be used as an end-to-end protocol between a location server and a target UE in order to estimate the location of the target UE using TA-based position-related measurements obtained by one or more reference sources, e.g., GNSS and NG-RAN. The following set of message types may be used to facilitate the necessary NTN TA configurations and capability exchange procedures:
Request Capabilities;
Provide Capabilities;
Request Assistance Data;
Provide Assistance Data.

Implementations described in this disclosure also provide for positioning preparation using capability exchange between a location server and a target UE. For instance, LPP signaling is used as an end-to-end protocol between a location server and a target UE to exchange capabilities to implement TA positioning. The location server, for instance, initiates the capability transfer procedure using request/provide capabilities messages to enable the transfer of capabilities related to support of TA-based positioning from the target UE to the location server. The exchange of capabilities information may be implemented for NTN devices and/or TN devices. In at least one implementation, the location server may use an IE (e.g., nr-TA-RequestCapabilities) to request the capability of the target UE to support TA-based positioning and to request TA-based positioning capabilities from the target UE. The request may include one or more of the following: support for TA-based positioning, support for a TA measurement window, user-specific TA location estimate (e.g., geodesic coordinates, latitude-longitude, distances (e.g., in meters, kilometers, etc.)), user-specific TA location estimate source, e.g., GNSS, Bluetooth, WiFi, etc., Satellite-mode, Satellite connectivity type, polarization capabilities, and so forth.

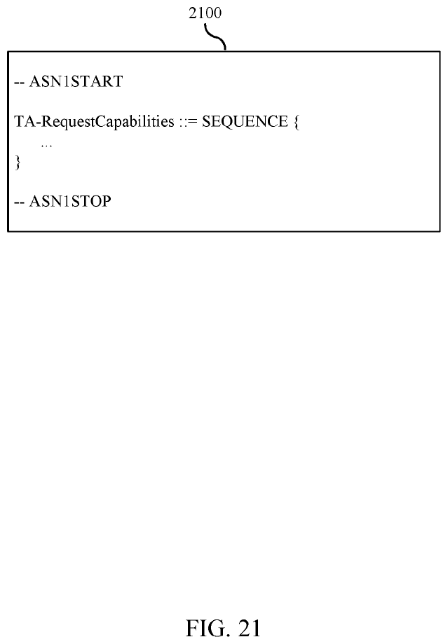

FIG. 21 depicts an example TA capabilities request IE 2100 that supports TA for positioning in accordance with aspects of the present disclosure. The TA capabilities request IE 2100, for instance, represents an instance of the nr-TA-RequestCapabilities IE.

In implementations, in response to a request capabilities message, the target UE indicates its capability to support NR TA positioning method and to provide its NR TA positioning capabilities to the location server by exchanging a ProvideCapabilities message. In one implementation, the target device may use an IE (e.g., nr-TA-ProvideCapabilities) to provide this information.

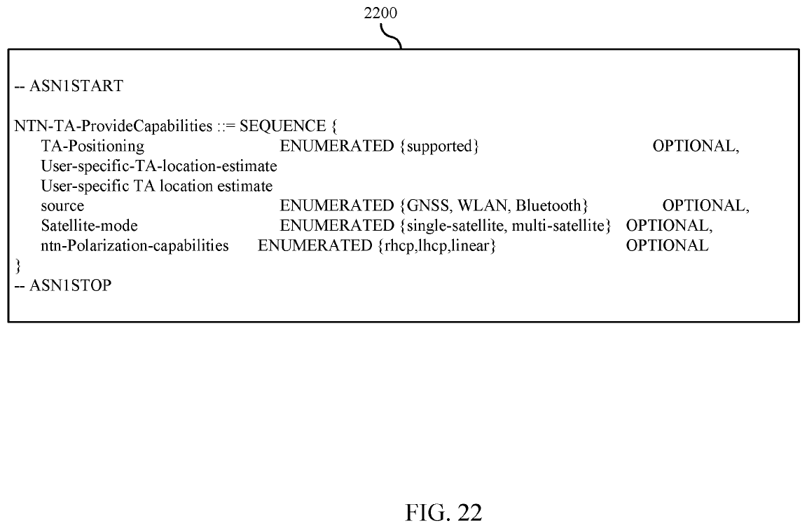

FIG. 22 depicts an example TA capabilities response IE 2200 that supports TA for positioning in accordance with aspects of the present disclosure. The TA capabilities response IE 2200, for instance, represents an instance of the namely nr-TA-ProvideCapabilities IE. In implementations, the IE may include information indicating whether the target UE supports TA-based positioning, which may be indicated through two bits where 0 may indicate not supported, while 1 may indicate supported. Further, information regarding the type(s) of location method(s) used for calculation of its own position estimates (e.g., which are further used in user specific TA calculation) can be indicated. For example, user specific TA calculation may be based on UE GNSS capability, and if a target UE does not have GNSS capability, then the target UE may indicate that TA positioning is not supported. In at least one implementation, user specific TA calculation may be based on location estimate using RAT-independent positioning methods, e.g., GNSS, Bluetooth, WLAN (such as Wi-Fi), etc. In such scenarios, a target UE may indicate these methods that may further be used for user-specific calculation. Further, other information regarding satellite coverage (e.g., single and/or multi-satellite TA methods) and the target UE polarization capabilities may be part of information exchange.

Implementations described in this disclosure also provide for information exchange between an NG-RAN node and a location server. For instance, in implementations NRPPa location information transfer procedures are used to handle the transfer of TA-based positioning related information between NTN NG-RAN node and a location server, e.g., LMF. An NRPPa procedure may be used for the exchange of information that may further be used by the location server to facilitate TA-based positioning using LPP. For example, this enables the LMF to request the NG-RAN node to transfer TA positioning method information to the LMF. An NRPPa procedure may be based on a TA information request message by an LMF to an NG-RAN node, where such message may request following information:

Cell Information: This may include information regarding Physical Cell Identity (PCI), Cell-ID, TAC, BWP-Id, etc. In addition, information regarding type of cell employed, e.g., earth-fixed, quasi earth-fixed, or earth moving cell may also be specified in order to correctly implement the TA positioning method.

Reference signal information: The location server may request parameters regarding type of reference signal to be used for TA positioning methods. For example, if PRS are to be used, information such as PRS bandwidth, PRS configuration index, PRS occasions group, and PRS frequency hopping configuration may be part of a request message. In at least one implementation, if PRS are to be used for TA measurements, the location server may initiate a PRS configuration exchange procedure to request the NG-RAN node to configure or update (e.g., turn off) PRS transmission.

TA-common parameters: The TA common parameters with epoch time and validity duration may be requested by the location server. In at least one implementation, multiple TA-common parameters for different time instances may be used by the LMF to implement a TA-based positioning method. In such scenarios, such a request may be included where a field may be used to indicate that the requested TA-common parameters are for different time instances. In at least one implementation, a time separation window between two TA-common parameters may also be included in the request, such as to enable an NG-RAN node to indicate whether one or multiple sets of TA-common parameters are to be used for TA-based positioning.

Ephemeris information: The satellite ephemeris information may be used by a target UE to calculate the user-specific TA and/or differential TA. The location server may request satellite ephemeris information for a single time instance and/or for multiple time instances, where the format type of the ephemeris information may also be indicated to NG-RAN node. In at least one implementation, the request may contain a single format, e.g., Format 1 (e.g., satellite position and velocity state vector) and/or Format 2, e.g., orbital parameter ephemeris format. In at least one implementation, ephemeris information in multiple formats may be requested.

Reference point coordinates: Information regarding a reference point (e.g., where uplink and downlink signals are frame aligned with an offset N_{TA,offset}) may also be requested and used for user-specific TA or differential TA calculations. Such information request may include reference point coordinates, reference point coordinates accuracy, and reference point position.

Polarization information: The polarization capabilities of a TRP (e.g., a satellite) may also be used by location server in order to avoid polarization mismatch errors during the TA measurements.

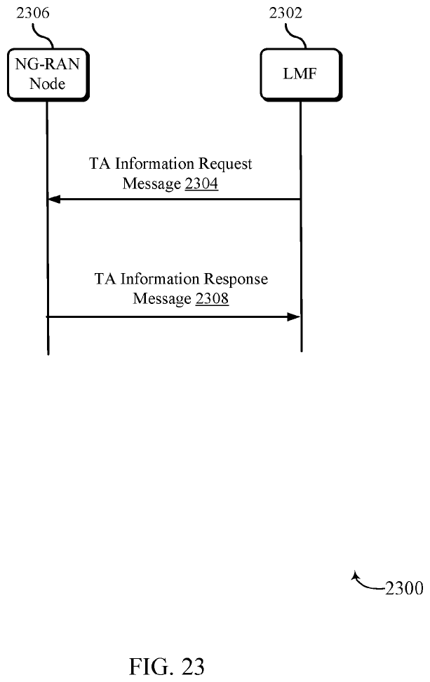

FIG. 23 depicts an example information exchange procedure 2300 that supports TA for positioning in accordance with aspects of the present disclosure. In the information exchange procedure 2300, an LMF 2302 transmits a TA information request message 2304 to an NG-RAN node 2306, and the NG-RAN node 2306 returns a TA information response message 2308 to the LMF 2302. The NG-RAN node 2306, for instance, includes in the TA information response message 2308 available TA information. The TA information response message 2308 may include requested information (e.g., as described above) that is available to NG-RAN node 2306. In at least one implementation, the NG-RAN node 2306 may also send extra information that is not request by the LMF 2302 (e.g., a location server) in the TA information request message 2304 but may be relevant to a TA positioning method.

In implementations, the LMF 2302 may also request the NG-RAN node 2306 to provide detailed information for TRPs hosted by the NG-RAN node 2306, where for transparent payload, the NG-RAN node 2306 may be a gNB on ground and a TRP may correspond to a satellite connected to the gNB on ground. For instance, such a request may indicate to the gNB to provide information about number of satellites it is connected. In addition, information about the satellite's ephemeris may also be part of request. This information may be used by a location server in order to configure resources, such as to avoid feeder link handover and/or to provide neighboring cell information for seamless connectivity and positioning calculation. Further, information such as Synchronization Signal Block (SSB) information, Cell-IDs, number of cells, cell layout configuration (e.g., earth moving cell and/or earth fixed cells) associated with each satellite may also be requested. This requested information may be part of the TA information request message 2304 or a separate request message may be used for this purpose, e.g., a TRP and/or NTN cell request message. After reception of this message, the gNB can include the requested information for TRPs/satellites hosted by the NG-RAN node 2306 in the via the TA information response message 2308 (e.g., if this information is requested in the TA information request message 2304) and/or in a TRP information response message, e.g., if this information is requested in a TRP information request message.

Implementations described in this disclosure also provide for positioning configuration using configuration exchange. For instance, in implementations and based on the capability exchange information (e.g., from target UE and/or NG-RAN node), the location server configures the target UE with the assistance that the target UE may use for estimation of target UE location. For instance, for this purpose, the location server may exchange request/provide assistance data (e.g., positioning configuration) with the target UE. In at least one implementation, the target UE may send a RequestAssistanceData message to the location server (e.g., for UE-based positioning), where an IE (e.g., nr-TA-RequestAssistanceData) may be used. The location server may provide assistance data in response to a request from the target UE (e.g., solicited assistance data) and/or in the absence of the request (e.g., unsolicited assistance data) such as by using a ProvideAssistanceData message, where an IE including the configuration parameters may be defined. This could be applicable to UE-specific configuration of the TA-based positioning method.

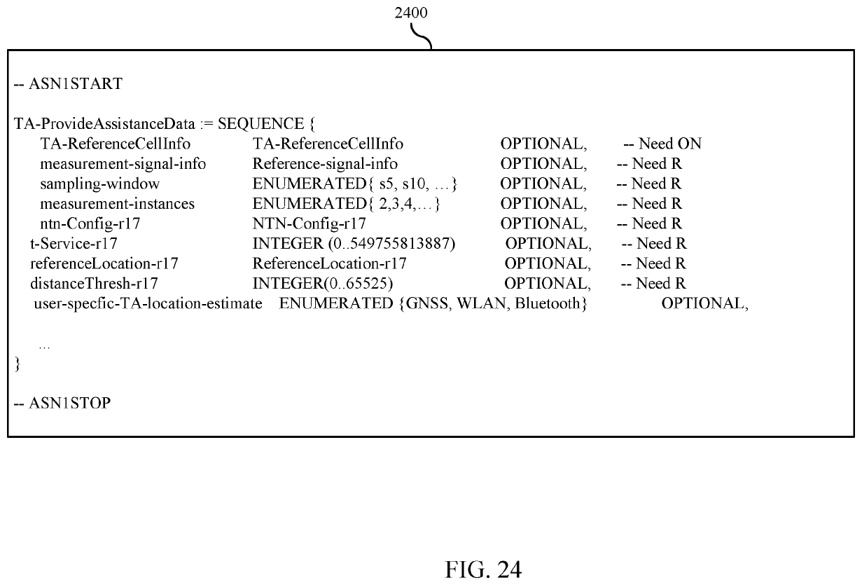

FIG. 24 depicts an example TA assistance data IE 2400 that supports TA for positioning in accordance with aspects of the present disclosure. The TA assistance data IE 2400, for instance, represents an instance of the TA-RequestCapabilities IE. The TA assistance data IE 2400 may include a set of fields to enable UE-assisted TA-based positioning method. An example description of the fields is below:

The IE “TA-ReferenceCellInfo” may be used by the location server to provide reference cell information for TA assistance data. The target UE may be in the coverage of multiple satellite with different cell-IDs or within the coverage of single satellite but with different beams corresponding to different cell-IDs. Therefore, the target UE may use information of the cell-ID and related parameters for a TA positioning method. For example, the IE may include information related to cell-ID, antenna-port configuration, CP-length, DL-bandwidth, etc. In at least one implementation, the TA-based measurements may be carried out on a cell that is different from a serving cell, so a field may be included that indicates that the relevant assistance data is different from serving cell. In at least one implementation, a field may be used to indicate that multiple measurements are to be performed on a same cell at different instances (e.g., for single-satellite TA-based positioning) or multiple measurements corresponding to different cell-IDs, e.g., multi-satellite or multi-beam TA-based positioning. In at least one implementation, if data related to one cell-ID is configured, then it can be assumed that the target UE may perform multiple measurements corresponding to single satellite, e.g., cell-edge-users and/or neighboring cell data for edge users. In at least one example, the target UE may perform measurements corresponding to a different satellite, cell-ID, and/or beam (e.g., on a neighbor cell) in addition to the measurements corresponding to a single satellite, e.g., when the UE is near a cell-edge.

In implementations, a target UE is indicated by a location server (e.g., LMF) about reference signals on which the TA measurements are to be performed. For this purpose, various types of reference signals (e.g., SSB, PRS, and/or CSI-RS) may be used. Information about reference signals may be part of IE “TA-ReferenceCellInfo” and/or a separate IE, e.g., measurement-signal-info may be used to indicate the type of reference signal to be used. The location server may include the reference signal configuration. For example, if DL-PRS are used for TA calculation and/or TA-based distance calculation, the IE PRS may be reutilized for this purpose, and may be indicated in IE “TA-ReferenceCellInfo”and/or within IE, “measurement-signal-info.” Further, if SSBs are to be used, the information related to SSBs may be configured.

The common and user specific TA related parameters may be configured through IE NTN-Config, that contains configurations for satellite ephemeris info (in format of position and velocity state vector and/or in format of orbital parameters), indication of the epoch time for assistance information (e.g., indicated by a System Frame Number (SFN) and a sub-frame number), and common TA parameters, e.g., TA-common, TA-common drift, TA-common drift variation. In at least one implementation, the configuration is valid for one TA calculation, (e.g., if configured) and a target UE calculates the distance (e.g., from P to S in the example 1700 of FIG. 17) and/or TA in its report at one time instance. In at least one implementation, the target UE may be indicated by the location server to perform multiple measurements at different time instances, where the TA parameters remain valid for an entire measurement duration. The validity of parameters may be indicated by a “validity duration” field, where the field defines a maximum time during which the target UE can apply the satellite ephemeris and/or common TA parameters without having to acquire new satellite ephemeris and/or common TA parameters.

In implementations, the target UE is configured with one set of TA-common and ephemeris parameters to perform TA measurements for location estimation at different time instances, where the measurement separation and/or time instances may be indicated using a field in assistance data IE. For example, a field (e.g., sampling-window and/or measurement-instance-separation) may be used to define the minimum separation between two measurements. Alternatively or additionally, a field (e.g., measurement-instances) may be used to indicate exact time instances relative to the epoch time for the measurements. In such scenarios, the target UE can perform the indicated number of TA measurements at the configured time instances and/TA measurements that satisfy the sampling-window condition by employing the same TA common parameters and ephemeris information.

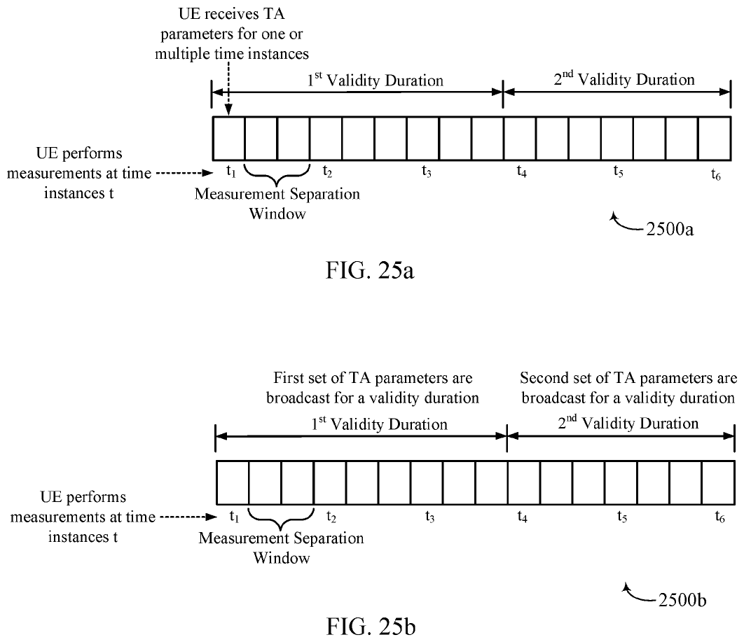

FIG. 25a illustrates an example scenario 2500a that supports TA for positioning in accordance with aspects of the present disclosure. In the scenario 2500a a target UE receives TA parameters with a validity duration, time instances of the measurements and/or separation gap of measurements (e.g., with respect to Epoch time) and a number of measurement instances. The target UE can perform measurements at the indicated time instances (e.g., t₁, t₂, t₃, etc.) using the same TA parameters (e.g., TA common and ephemeris parameters used at t₁) during the respective validity durations.

In at least one example, a target UE is configured with one set of TA parameters that are the same over a validity duration. The target UE can be configured to perform measurement at multiple time instances, and the TA parameters used at different time instances for location and/or distance estimates may not be the same and are derived from initial TA parameters using a prediction model. In such scenarios, a UE may additionally be indicated to perform measurements based on prediction.

In implementations, different set of TA parameters for different time instances (e.g., different TA common and ephemeris parameters for time instances t₁, t₂, t₃, etc. in the scenario 2500a) are configured by a location server in one configuration message, where these parameters are valid within a validity duration. For example, using the example in the scenario 2500a, three sets of TA common parameters and ephemeris information are configured, each corresponding to time instances t₁, t₂, and t₃. In at least one implementation, a separate field may be used to indicate that different TA parameters are configured for multiple time instances. In at least one implementation, only the ephemeris information at time instances is different while TA common parameters are the same.

In implementations, a UE is configured with multiple sets of TA parameters (e.g., in one configuration message) where each set of parameters is valid for one validity duration. For example, using the example in the scenario 2500a, the target UE may be configured with two sets of TA common and ephemeris information parameters indicated by respective validity durations, where first set is valid for measurement instances t₁, t₂, and t₃, while second set is valid for measurements at t₄, t₅, and t₆.

In addition to above mentioned fields, the target UE may also be configured with type of positioning method (e.g., RAT independent) that is used to locate its position for user-specific TA, e.g., using a field indicating the method type. In the absence of the field, the positioning method choice can be made by the target UE itself. In at least one implementation, the polarization types to be used for the uplink and downlink reference signals may also be configured through the NTN IE.

In implementations, TA parameters that are common to a set of target UEs are broadcast via Positioning System Information Blocks (posSIBs) that are carried in RRC System Information (SI) messages. In such scenarios, TA positioning method related common and generic assistance data IEs can be transmitted over the posSIBs. Further, TA parameters that are common to users in a cell and are defined in NTN System Information Block (SIB)-19 (e.g., defined in IE NTN-Config) are broadcast through posSIB, where a posSIB type for TA positioning method may be defined. In at least one implementation, the TA parameters are broadcast periodically, where each set of parameters is valid for a validity duration. The information such as number of measurements and reference signal type may be configured through assistance data IEs. The target UE can look for TA parameters (e.g., common TA parameters and ephemeris information) in the broadcast message and can perform TA measurements for the number of time instances that are configured through assistance data. The number of measurements may fall in two or more validity durations. Thus, two or more sets of TA parameters may be used for positioning related measurements.

FIG. 25b illustrates an example scenario 2500b that supports TA for positioning in accordance with aspects of the present disclosure. In the scenario 2500b a target UE may be configured to perform measurements at t₃ t₄, and t₅. In this example, the target UE may use a 1^{st} set of TA parameters at t₃, and a second set of TA parameters are used for t₄ and t₅ time instances. In at least one example, multiple set of TA parameters are mapped to one validity duration where each set corresponds to one or more time instances within a validity duration and this information is broadcasted periodically.

In implementations, a location server employs an assistance information control procedure to signal positioning assistance information to an NG-RAN node for TA assistance information broadcasting, where such procedure may be initiated by sending an assistance information control message to the NG-RAN node (e.g., gNB) by the location server, e.g., LMF). Based on the received signal positioning assistance information from an IE in the assistance information control message, the NG-RAN node can implement broadcasting of TA information. For example, if the IE contains new parameters for broadcasting, the NG-RAN node can replace previously stored information and use the received information to configure assistance information broadcasting. In at least one implementation, the IE may contain the information about broadcasting priority of the assistance data, e.g., validity duration, ephemeris data, etc. In such scenarios, the NG-RAN node may take it into account this information when configuring broadcasting for the relevant information, where assistance information having the same broadcast priority value may receive the same treatment, e.g., broadcast by the NG-RAN node or not broadcast. In at least one example, a start and stop field are set in the assistance information control message to indicate when to start and/or stop broadcasting. In such scenarios, the NG-RAN node may follow to start or stop the TA parameter broadcasting as indicated.

Implementations described in this disclosure also support TA-based positioning configuration and capability exchange for multiple satellite systems. For instance, in implementations the location server configures TA parameters to a target UE where the parameters are related to multiple satellites (and/or cell-IDs) that may be associated with one NG-RAN node or multiple NG-RAN nodes. The configuration may be based on the information received during capability exchange between location server and target device, and/or between the location server and NG-RAN node(s).

In implementations, the location server exchanges information with the target UE about the target UE's multi-satellite connectivity. Such information, for instance, may be acquired by the target UE, such as from the number of cells to which it is connected. In at least one implementation, this information may be provided to the location server in the provide capability message. The location server may have the information about the mapping of cell IDs with satellite ephemeris and NG-RAN nodes and/or may request this information from the AMF and/or NG-RAN nodes.

Based on its determination of a number of satellite nodes (e.g., TRPs) that are connected to the target UE and corresponding NG-RAN nodes, the location server may initiate NRPPa location information transfer procedures with the concerned NG-RAN nodes. The NRPPa procedure discussed above may be applied to each of the NG-RAN nodes. In at least one example, where one NG-RAN node is serving through multiple satellites, the TA parameters for each satellite node may explicitly be included in the TA response message by the NG-RAN node.

In implementations, the location server may use a TRP information request message to an NG-RAN node to determine the TA parameters for the satellites that are connected to the NG-RAN node, where a TRP may correspond to a satellite in an NTN transparent payload architecture. The information request message may include a list of satellites for which TA parameters related information is requested. The NG-RAN node can reply with a TRP information response message, where information such as ephemeris data, TA parameters, cell information, and reference point for the respective satellite can be included in the response message.

In implementations, the location server configures TA parameters for different satellites to the target UE, where each set of TA parameters can be associated with a cell-ID. For instance, the parameters listed in the TA-ProvideAssistanceData IE may be associated with a TA cell information, and this IE may divide parameters into satellite common and satellite specific parameters. The satellite common parameters are common parameters and can apply for each of the node, e.g., user specific TA location estimate method. The satellite specific parameters may include ephemeris information, TA common parameters, etc.

In implementations, a parameter field is included in the IE that indicates that TA measurements are to be carried for different satellite nodes and is not based on single satellite measurements. If indicated as multi-satellite measurements, the target UE may perform single TA calculation for each satellite node, and if not indicated as multi-satellite measurements perform multiple measurements.

In implementations, for each of the satellite node, the TA parameters that are common to users in a cell (and/or satellite) can be broadcast via posSIBs. The target UE may separately be configured through assistance data IEs about the initiation of TA measurements using TA parameters of different satellite nodes.

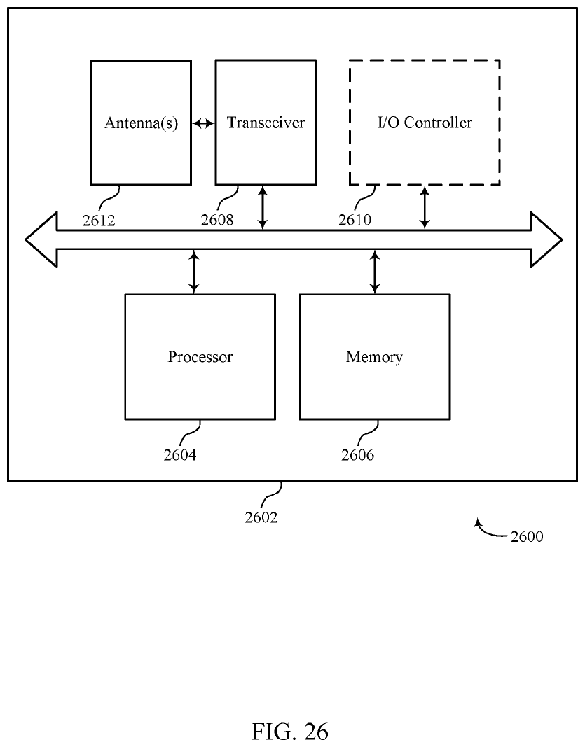

FIG. 26 illustrates an example of a block diagram 2600 of a device 2602 (e.g., an apparatus) that supports TA for positioning in accordance with aspects of the present disclosure. The device 2602 may be an example of UE 104 as described herein. The device 2602 may support wireless communication with one or more network entities 102, UEs 104, or any combination thereof. The device 2602 may include components for bi-directional communications including components for transmitting and receiving communications, such as a processor 2604, a memory 2606, a transceiver 2608, and an I/O controller 2610. These components may be in electronic communication or otherwise coupled (e.g., operatively, communicatively, functionally, electronically, electrically) via one or more interfaces (e.g., buses).

The processor 2604, the memory 2606, the transceiver 2608, or various combinations thereof or various components thereof may be examples of means for performing various aspects of the present disclosure as described herein. For example, the processor 2604, the memory 2606, the transceiver 2608, or various combinations or components thereof may support a method for performing one or more of the operations described herein.

In some implementations, the processor 2604, the memory 2606, the transceiver 2608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 2604 and the memory 2606 coupled with the processor 2604 may be configured to perform one or more of the functions described herein (e.g., executing, by the processor 2604, instructions stored in the memory 2606). In the context of UE 104, for example, the transceiver 2608 and the processor coupled 2604 coupled to the transceiver 2608 are configured to cause the UE 104 to perform the various described operations and/or combinations thereof.

For example, the processor 2604 and/or the transceiver 2608 may support wireless communication at the device 2602 in accordance with examples as disclosed herein. For instance, the processor 2604 and/or the transceiver 2608 may be configured as and/or otherwise support a means to receive an assistance configuration message indicating to perform a plurality of TA measurements corresponding to a plurality of measurement time instances, where: each measurement time instance is associated with at least one cell, and the assistance configuration message includes TA related parameters and measurement reference signal configuration corresponding to the at least one cell; perform at least one TA measurement corresponding to at least one of the plurality of measurement time instances and based at least in part on the received assistance configuration message; and transmit a TA positioning report including the at least one TA measurement.

Further, in some implementations, the TA related parameters include at least one of satellite ephemeris information, epoch time, common TA parameters, or validity duration; the plurality of measurement time instances includes time instances within a validity duration; the assistance configuration message includes a measurement instance separation information, and the processor is configured to cause the apparatus to determine the plurality of measurement time instances based at least in part on the measurement instance separation information; a first subset of the plurality of measurement time instances includes time instances within a first validity duration, and a second subset of the plurality of measurement time instances includes time instances within a second validity duration; the first validity duration is associated with a first set of one or more of satellite ephemeris or common TA parameters, and the second validity duration is associated with a second set of one or more of satellite ephemeris or common TA parameters.

Further, in some implementations, a first subset of the plurality of measurement time instances is associated with a first cell of the at least one cell, and a second subset of the plurality of measurement time instances is associated with a second cell of the at least one cell; the processor is configured to cause the apparatus to receive a TA parameter broadcast message for positioning, and the TA parameter broadcast message includes information about at least one of satellite ephemeris info, epoch time, common TA parameters, validity duration, or reference point; the processor is configured to cause the apparatus to receive the TA parameter broadcast message periodically, and the TA parameter broadcast message is associated with at least one validity duration; the processor is configured to cause the apparatus to: receive a capability information request from a network related to TA based positioning; and transmit one or more capability parameters based at least in part on the capability information request; the capability information request includes information about indication of support for TA calculations for positioning; the capability information request includes information about support of user specific TA location estimate method; the one or more capability parameters include at least one of an indication of support of TA positioning calculation for positioning, a user-specific TA location estimate method, a number of satellite nodes in a coverage area, or polarization capability.

The processor 2604 of the device 2602, such as a UE 104, may support wireless communication in accordance with examples as disclosed herein. The processor 2604 includes at least one controller coupled with at least one memory, and is configured to and/or operable to cause the processor to receive an assistance configuration message indicating to perform a plurality of TA measurements corresponding to a plurality of measurement time instances, wherein: each measurement time instance is associated with at least one cell, and the assistance configuration message comprises TA related parameters and measurement reference signal configuration corresponding to the at least one cell; perform at least one TA measurement corresponding to at least one of the plurality of measurement time instances and based at least in part on the received assistance configuration message; and transmit a TA positioning report comprising the at least one TA measurement. Further, the processor 2604 and the at least one controller are configured to and/or operable to cause the processor to perform any one or more operations discussed herein with reference to a UE, such as a UE 104.

The processor 2604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 2604 may be configured to operate a memory array using a memory controller. In some other implementations, a memory controller may be integrated into the processor 2604. The processor 2604 may be configured to execute computer-readable instructions stored in a memory (e.g., the memory 2606) to cause the device 2602 to perform various functions of the present disclosure.

The memory 2606 may include random access memory (RAM) and read-only memory (ROM). The memory 2606 may store computer-readable, computer-executable code including instructions that, when executed by the processor 2604 cause the device 2602 to perform various functions described herein. The code may be stored in a non-transitory computer-readable medium such as system memory or another type of memory. In some implementations, the code may not be directly executable by the processor 2604 but may cause a computer (e.g., when compiled and executed) to perform functions described herein. In some implementations, the memory 2606 may include, among other things, a basic I/O system (BIOS) which may control basic hardware or software operation such as the interaction with peripheral components or devices.

The I/O controller 2610 may manage input and output signals for the device 2602. The I/O controller 2610 may also manage peripherals not integrated into the device M02. In some implementations, the I/O controller 2610 may represent a physical connection or port to an external peripheral. In some implementations, the I/O controller 2610 may utilize an operating system such as iOS®, ANDROID®, MS-DOS®, MS-WINDOWS®, OS/2®, UNIX®, LINUX®, or another known operating system. In some implementations, the I/O controller 2610 may be implemented as part of a processor, such as the processor M08. In some implementations, a user may interact with the device 2602 via the I/O controller 2610 or via hardware components controlled by the I/O controller 2610.

In some implementations, the device 2602 may include a single antenna 2612. However, in some other implementations, the device 2602 may have more than one antenna 2612 (e.g., multiple antennas), including multiple antenna panels or antenna arrays, which may be capable of concurrently transmitting or receiving multiple wireless transmissions. The transceiver 2608 may communicate bi-directionally, via the one or more antennas 2612, wired, or wireless links as described herein. For example, the transceiver 2608 may represent a wireless transceiver and may communicate bi-directionally with another wireless transceiver. The transceiver 2608 may also include a modem to modulate the packets, to provide the modulated packets to one or more antennas 2612 for transmission, and to demodulate packets received from the one or more antennas 2612.

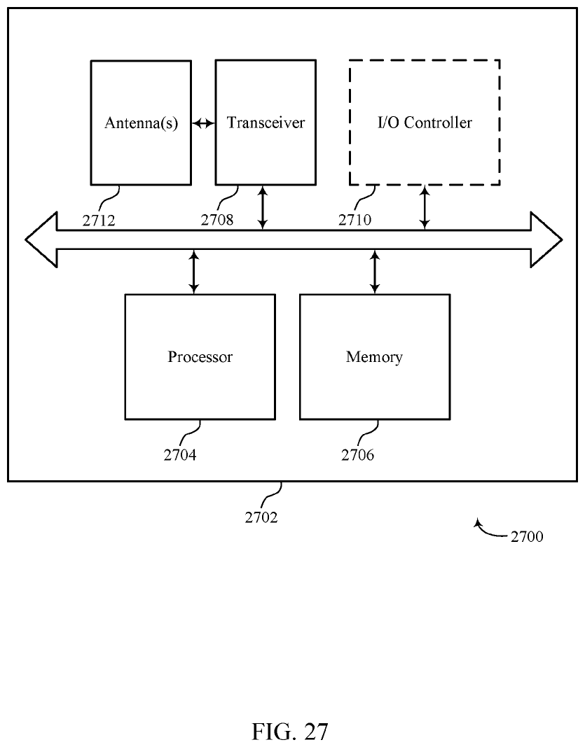

FIG. 27 illustrates an example of a block diagram 2700 of a device 2702 (e.g., an apparatus) that supports TA for positioning in accordance with aspects of the present disclosure. The device 2702 may be an example of a network entity 102 as described herein. The device 2702 may support wireless communication with one or more network entities 102, UEs 104, or any combination thereof. The device 2702 may include components for bi-directional communications including components for transmitting and receiving communications, such as a processor 2704, a memory 2706, a transceiver 2708, and an I/O controller 2710. These components may be in electronic communication or otherwise coupled (e.g., operatively, communicatively, functionally, electronically, electrically) via one or more interfaces (e.g., buses).

The processor 2704, the memory 2706, the transceiver 2708, or various combinations thereof or various components thereof may be examples of means for performing various aspects of the present disclosure as described herein. For example, the processor 2704, the memory 2706, the transceiver 2708, or various combinations or components thereof may support a method for performing one or more of the operations described herein.

In some implementations, the processor 2704, the memory 2706, the transceiver 2708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 2704 and the memory 2706 coupled with the processor 2704 may be configured to perform one or more of the functions described herein (e.g., executing, by the processor 2704, instructions stored in the memory 2706). In the context of network entity 102, for example, the transceiver 2708 and the processor 2704 coupled to the transceiver 2708 are configured to cause the network entity 102 to perform the various described operations and/or combinations thereof.

For example, the processor 2704 and/or the transceiver 2708 may support wireless communication at the device 2702 in accordance with examples as disclosed herein. For instance, the processor 2704 and/or the transceiver 2708 may be configured as or otherwise support a means to transmit an assistance configuration message indicating to perform a plurality of TA measurements corresponding to a plurality of measurement time instances, where: each measurement time instance is associated with at least one cell, and the assistance configuration message includes TA related parameters and measurement reference signal configuration corresponding to the at least one cell; and receive a TA positioning report including at least one TA measurement based at least in part on the assistance configuration message.

Further, in some implementations, the TA related parameters include at least one of satellite ephemeris information, epoch time, common TA parameters, or validity duration; the plurality of measurement time instances includes time instances within a validity duration; the assistance configuration message includes a measurement instance separation information; a first subset of the plurality of measurement time instances includes time instances within a first validity duration, and a second subset of the plurality of measurement time instances includes time instances within a second validity duration; the first validity duration is associated with a first set of one or more of satellite ephemeris or common TA parameters, and the second validity duration is associated with a second set of one or more of satellite ephemeris or common TA parameters; the processor is configured to cause the apparatus to: transmit, from a network related to TA based positioning, a capability information request; and receive one or more capability parameters based at least in part on the capability information request.

The processor 2704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 2704 may be configured to operate a memory array using a memory controller. In some other implementations, a memory controller may be integrated into the processor 2704. The processor 2704 may be configured to execute computer-readable instructions stored in a memory (e.g., the memory 2706) to cause the device 2702 to perform various functions of the present disclosure.

The memory 2706 may include random access memory (RAM) and read-only memory (ROM). The memory 2706 may store computer-readable, computer-executable code including instructions that, when executed by the processor 2704 cause the device 2702 to perform various functions described herein. The code may be stored in a non-transitory computer-readable medium such as system memory or another type of memory. In some implementations, the code may not be directly executable by the processor 2704 but may cause a computer (e.g., when compiled and executed) to perform functions described herein. In some implementations, the memory 2706 may include, among other things, a basic I/O system (BIOS) which may control basic hardware or software operation such as the interaction with peripheral components or devices.

The I/O controller 2710 may manage input and output signals for the device 2702. The I/O controller 2710 may also manage peripherals not integrated into the device M02. In some implementations, the I/O controller 2710 may represent a physical connection or port to an external peripheral. In some implementations, the I/O controller 2710 may utilize an operating system such as iOS®, ANDROID®, MS-DOS®, MS-WINDOWS®, OS/2®, UNIX®, LINUX®, or another known operating system. In some implementations, the I/O controller 2710 may be implemented as part of a processor, such as the processor M06. In some implementations, a user may interact with the device 2702 via the I/O controller 2710 or via hardware components controlled by the I/O controller 2710.

In some implementations, the device 2702 may include a single antenna 2712. However, in some other implementations, the device 2702 may have more than one antenna 2712 (e.g., multiple antennas), including multiple antenna panels or antenna arrays, which may be capable of concurrently transmitting or receiving multiple wireless transmissions. The transceiver 2708 may communicate bi-directionally, via the one or more antennas 2712, wired, or wireless links as described herein. For example, the transceiver 2708 may represent a wireless transceiver and may communicate bi-directionally with another wireless transceiver. The transceiver 2708 may also include a modem to modulate the packets, to provide the modulated packets to one or more antennas 2712 for transmission, and to demodulate packets received from the one or more antennas 2712.

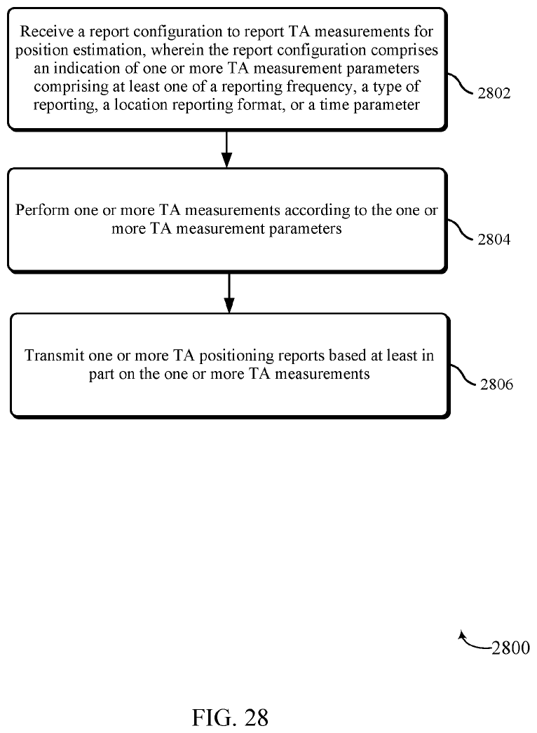

FIG. 28 illustrates a flowchart of a method 2800 that supports TA for positioning in accordance with aspects of the present disclosure. The operations of the method 2800 may be implemented by a device or its components as described herein. For example, the operations of the method 2800 may be performed by a UE 104 as described with reference to FIGS. 1 through 27. In some implementations, the device may execute a set of instructions to control the function elements of the device to perform the described functions. Additionally, or alternatively, the device may perform aspects of the described functions using special-purpose hardware.

At 2802, the method may include receiving a report configuration to report TA measurements for position estimation, wherein the report configuration comprises an indication of one or more TA measurement parameters comprising at least one of a reporting frequency, a type of reporting, a location reporting format, or a time parameter. The operations of 2802 may be performed in accordance with examples as described herein. In some implementations, aspects of the operations of 2802 may be performed by a device as described with reference to FIG. 1.

At 2804, the method may include performing one or more TA measurements according to the one or more TA measurement parameters. The operations of 2804 may be performed in accordance with examples as described herein. In some implementations, aspects of the operations of 2804 may be performed by a device as described with reference to FIG. 1.

At 2806, the method may include transmitting one or more TA positioning reports based at least in part on the one or more TA measurements. The operations of 2806 may be performed in accordance with examples as described herein. In some implementations, aspects of the operations of 2806 may be performed by a device as described with reference to FIG. 1.

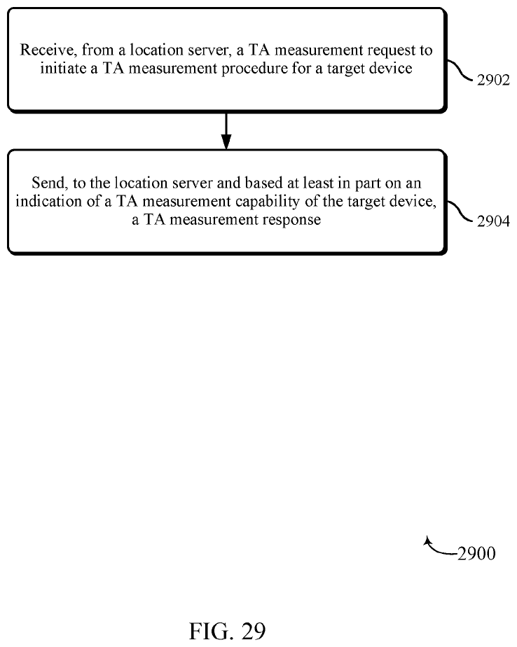

FIG. 29 illustrates a flowchart of a method 2900 that supports TA for positioning in accordance with aspects of the present disclosure. The operations of the method 2900 may be implemented by a device or its components as described herein. For example, the operations of the method 2900 may be performed by a network entity 102 as described with reference to FIGS. 1 through 27. In some implementations, the device may execute a set of instructions to control the function elements of the device to perform the described functions. Additionally, or alternatively, the device may perform aspects of the described functions using special-purpose hardware.

At 2902, the method may include receiving, from a location server, a TA measurement request to initiate a TA measurement procedure for a target device. The operations of 2902 may be performed in accordance with examples as described herein. In some implementations, aspects of the operations of 2902 may be performed by a device as described with reference to FIG. 1.

At 2904, the method may include sending, to the location server and based at least in part on an indication of a TA measurement capability of the target device, a TA measurement response. The operations of 2904 may be performed in accordance with examples as described herein. In some implementations, aspects of the operations of 2904 may be performed by a device as described with reference to FIG. 1.

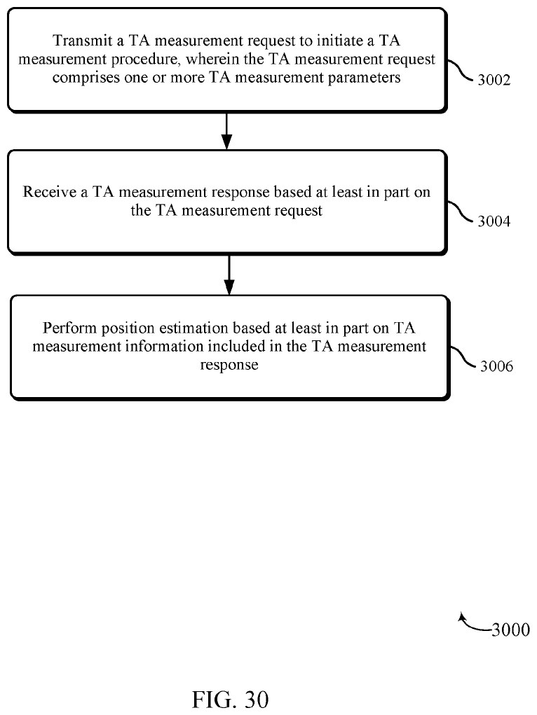

FIG. 30 illustrates a flowchart of a method 3000 that supports TA for positioning in accordance with aspects of the present disclosure. The operations of the method 3000 may be implemented by a device or its components as described herein. For example, the operations of the method 3000 may be performed by a network entity 102 as described with reference to FIGS. 1 through 27. In some implementations, the device may execute a set of instructions to control the function elements of the device to perform the described functions. Additionally, or alternatively, the device may perform aspects of the described functions using special-purpose hardware.

At 3002, the method may include transmitting a TA measurement request to initiate a TA measurement procedure, wherein the TA measurement request comprises one or more TA measurement parameters. The operations of 3002 may be performed in accordance with examples as described herein. In some implementations, aspects of the operations of 3002 may be performed by a device as described with reference to FIG. 1.

At 3004, the method may include receiving a TA measurement response based at least in part on the TA measurement request. The operations of 3004 may be performed in accordance with examples as described herein. In some implementations, aspects of the operations of 3004 may be performed by a device as described with reference to FIG. 1.

At 3006, the method may include performing position estimation based at least in part on TA measurement information included in the TA measurement response. The operations of 3006 may be performed in accordance with examples as described herein. In some implementations, aspects of the operations of 3006 may be performed by a device as described with reference to FIG. 1.

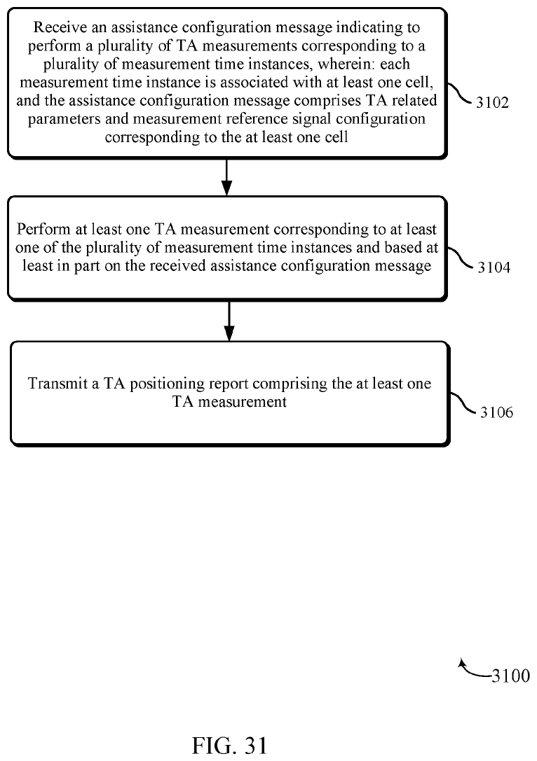

FIG. 31 illustrates a flowchart of a method 3100 that supports TA for positioning in accordance with aspects of the present disclosure. The operations of the method 3100 may be implemented by a device or its components as described herein. For example, the operations of the method 3100 may be performed by a UE 104 as described with reference to FIGS. 1 through 27. In some implementations, the device may execute a set of instructions to control the function elements of the device to perform the described functions. Additionally, or alternatively, the device may perform aspects of the described functions using special-purpose hardware.

At 3102, the method may include receiving an assistance configuration message indicating to perform a plurality of TA measurements corresponding to a plurality of measurement time instances, wherein: each measurement time instance is associated with at least one cell, and the assistance configuration message comprises TA related parameters and measurement reference signal configuration corresponding to the at least one cell. The operations of 3102 may be performed in accordance with examples as described herein. In some implementations, aspects of the operations of 3102 may be performed by a device as described with reference to FIG. 1.

At 3104, the method may include performing at least one TA measurement corresponding to at least one of the plurality of measurement time instances and based at least in part on the received assistance configuration message. The operations of 3104 may be performed in accordance with examples as described herein. In some implementations, aspects of the operations of 3104 may be performed by a device as described with reference to FIG. 1.

At 3106, the method may include transmitting a TA positioning report comprising the at least one TA measurement. The operations of 3106 may be performed in accordance with examples as described herein. In some implementations, aspects of the operations of 3106 may be performed by a device as described with reference to FIG. 1.

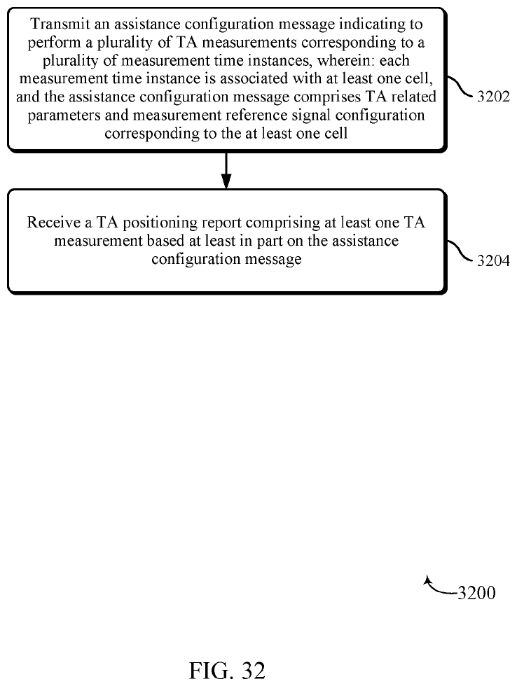

FIG. 32 illustrates a flowchart of a method 3200 that supports TA for positioning in accordance with aspects of the present disclosure. The operations of the method 3200 may be implemented by a device or its components as described herein. For example, the operations of the method 3200 may be performed by a network entity 102 as described with reference to FIGS. 1 through 27. In some implementations, the device may execute a set of instructions to control the function elements of the device to perform the described functions. Additionally, or alternatively, the device may perform aspects of the described functions using special-purpose hardware.

At 3202, the method may include transmitting an assistance configuration message indicating to perform a plurality of TA measurements corresponding to a plurality of measurement time instances, wherein: each measurement time instance is associated with at least one cell, and the assistance configuration message comprises TA related parameters and measurement reference signal configuration corresponding to the at least one cell. The operations of 3202 may be performed in accordance with examples as described herein. In some implementations, aspects of the operations of 3202 may be performed by a device as described with reference to FIG. 1.

At 3204, the method may include receiving a TA positioning report comprising at least one TA measurement based at least in part on the assistance configuration message. The operations of 3204 may be performed in accordance with examples as described herein. In some implementations, aspects of the operations of 3204 may be performed by a device as described with reference to FIG. 1.

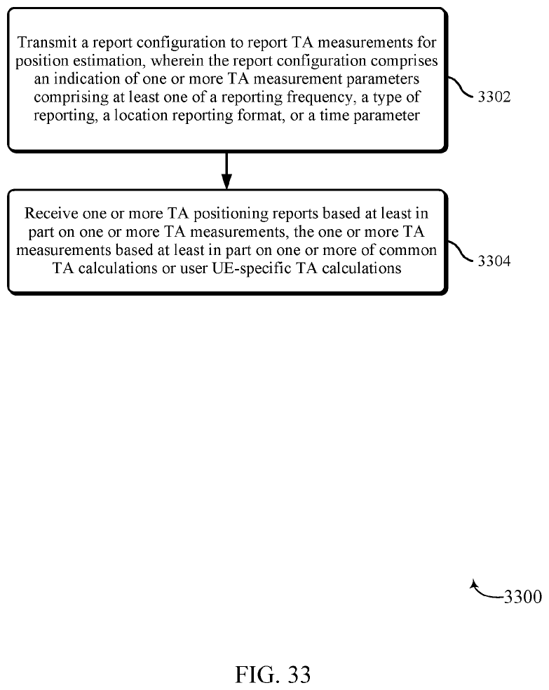

FIG. 33 illustrates a flowchart of a method 3300 that supports TA for positioning in accordance with aspects of the present disclosure. The operations of the method 3300 may be implemented by a device or its components as described herein. For example, the operations of the method 3300 may be performed by a network entity 102 as described with reference to FIGS. 1 through 27. In some implementations, the device may execute a set of instructions to control the function elements of the device to perform the described functions. Additionally, or alternatively, the device may perform aspects of the described functions using special-purpose hardware.

At 3302, the method may include transmitting a report configuration to report TA measurements for position estimation, the report configuration including an indication of one or more TA measurement parameters comprising at least one of a reporting frequency, a type of reporting, a location reporting format, or a time parameter. The operations of 3302 may be performed in accordance with examples as described herein. In some implementations, aspects of the operations of 3302 may be performed by a device as described with reference to FIG. 1.

At 3304, the method may include receiving one or more TA positioning reports based at least in part on one or more TA measurements, the one or more TA measurements based at least in part on one or more of common TA calculations or UE-specific TA calculations. The operations of 3304 may be performed in accordance with examples as described herein. In some implementations, aspects of the operations of 3304 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a message that indicates to perform a plurality of timing advance (TA) measurements corresponding to a plurality of measurement time instances, wherein each measurement time instance is associated with at least one cell, and wherein the message further indicates TA related parameters and reference signal configuration corresponding to the at least one cell;
perform at least one TA measurement corresponding to at least one of the plurality of measurement time instances; and
transmit a report comprising the at least one TA measurement.

2. The UE of claim 1, wherein the TA related parameters comprise at least one of satellite ephemeris information, epoch time, common TA parameters, or validity duration.

3. The UE of claim 1, wherein the plurality of measurement time instances comprises time instances within a validity duration.

4. The UE of claim 3, wherein the message comprises measurement instance separation information, and wherein the at least one processor is operable to cause the UE to determine the plurality of measurement time instances based at least in part on the measurement instance separation information.

5. The UE of claim 1, wherein a first subset of the plurality of measurement time instances comprises time instances within a first validity duration, and a second subset of the plurality of measurement time instances comprises time instances within a second validity duration.

6. The UE of claim 5, wherein the first validity duration is associated with a first set of one or more of satellite ephemeris or common TA parameters, and the second validity duration is associated with a second set of one or more of satellite ephemeris or common TA parameters.

7. The UE of claim 1, wherein a first subset of the plurality of measurement time instances is associated with a first cell of the at least one cell, and a second subset of the plurality of measurement time instances is associated with a second cell of the at least one cell.

8. The UE of claim 1, wherein the at least one processor is operable to cause the UE to receive a TA parameter broadcast message for positioning, and wherein the TA parameter broadcast message comprises information about at least one of satellite ephemeris info, epoch time, common TA parameters, validity duration, or reference point.

9. The UE of claim 8, wherein the at least one processor is operable to cause the UE to receive the TA parameter broadcast message periodically, and wherein the TA parameter broadcast message is associated with at least one validity duration.

10. The UE of claim 1, wherein the at least one processor is operable to cause the UE to:
receive a capability information request from a network related to TA based positioning; and
transmit one or more capability parameters based at least in part on the capability information request.

11. The UE of claim 10, wherein the capability information request comprises information about indication of support for TA calculations for positioning.

12. The UE of claim 10, wherein the capability information request comprises information about support of user specific TA location estimate method.

13. The UE of claim 10, wherein the one or more capability parameters comprise at least one of an indication of support of TA positioning calculation for positioning, a user-specific TA location estimate method, a number of satellite nodes in a coverage area, or polarization capability.

14. (canceled)

15. (canceled)

16. (canceled)

17. (canceled)

18. (canceled)

19. A network entity for wireless communication, comprising:
at least one memory; and
at least one processor coupled with the at least one memory and operable to cause the network entity to:
transmit a message that indicates to perform a plurality of timing advance (TA) measurements corresponding to a plurality of measurement time instances, wherein each measurement time instance is associated with at least one cell, and wherein the message further indicates TA related parameters and reference signal configuration corresponding to the at least one cell; and
receive a report comprising at least one TA measurement.

20. A method performed by a user equipment (UE), the method, comprising:
receiving a message that indicates to perform a plurality of timing advance (TA) measurements corresponding to a plurality of measurement time instances, wherein each measurement time instance is associated with at least one cell, and wherein the message further indicates TA related parameters and reference signal configuration corresponding to the at least one cell;
performing at least one TA measurement corresponding to at least one of the plurality of measurement time instances; and
transmitting a report comprising the at least one TA measurement.

21. The method of claim 20, wherein wherein the TA related parameters comprise satellite ephemeris information.

22. The method of claim 21, wherein the satellite ephemeris information comprises one or more of satellite position information or satellite velocity information.

23. The UE of claim 1, wherein the TA related parameters comprise satellite ephemeris information, and the satellite ephemeris information comprises one or more of satellite position information or satellite velocity information.

24. The network entity of claim 19, wherein the at least one processor is operable to cause the network entity to:
transmit one or more of the TA related parameters to a location management function (LMF).

25. A method performed by a network entity, the method comprising:
transmitting a message that indicates to perform a plurality of timing advance (TA) measurements corresponding to a plurality of measurement time instances, wherein each measurement time instance is associated with at least one cell, and wherein the message further indicates TA related parameters and reference signal configuration corresponding to the at least one cell; and
receiving a report comprising at least one TA measurement.
